(19) United States
(12) Patent Application Publication
(10) Pub. No.: US 2025/0304727 A1
(43) Pub. Date: Oct. 2, 2025

(54) PHOTOINITIATOR PACKAGE COMPRISING PHOSPHINE OXIDE PHOTOINITIATORS, COUMARIN-BASED SENSITIZERS AND AMINE ADDITIVES

(71) Applicant: IGM GROUP B. V., Waalwijk (NL)

(72) Inventors: Marika Morone, Lipomo (IT); Emilio Cremona, Venegono Superiore (IT)

(21) Appl. No.: 18/861,655

(22) PCT Filed: May 5, 2023
(86) PCT No.: PCT/EP2023/061940

§ 371 Date: Oct. 30, 2024

(30) Foreign Application Priority Data
May 6, 2022 (EP) 22172070.9

(51) Int. Cl. C08F 2/50; C09D 11/03; C09D 11/101; C09D 11/38

(52) U.S. Cl. CPC C08F 2/50; C09D 11/03; C09D 11/101; C09D 11/38

(57) ABSTRACT

A photoinitiator package comprising one or more mono- or bisacylphosphine oxide photoinitiators, one or more coumarin-based sensitizers and one or more amines, a photopolymerizable composition comprising the photoinitiator package and suitable polymerizable compounds, a method for polymerizing the photopolymerizable composition, a use of the photoinitiator package in photopolymerization applications and a use of a combination of one or more amines and one or more coumarin-based sensitizers for increasing the rate of surface curing in photopolymerizable compositions comprising Norrish Type-I photoinitiators.

### FIELD OF THE INVENTION

The present invention relates to a photoinitiator package comprising one or more mono- or bisacylphosphine oxide photoinitiators, one or more coumarin-based sensitizers and one or more amines, a photopolymerizable composition comprising the photoinitiator package and suitable polymerizable compounds, a method for polymerizing the photopolymerizable composition, a use of the photoinitiator package in photopolymerization applications and a use of combination of one or more amines and one or more coumarin-based sensitizers for increasing the rate of surface curing in photopolymerizable compositions comprising Norrish Type-I photoinitiators.

### BACKGROUND TO THE INVENTION

Photoinitiators for promoting the radical polymerisation of ethylenically unsaturated compounds may be classed as either Norrish Type-I, wherein an electronically excited photoinitiator fractures to form a free radical that acts to initiate the radical polymerisation, or Norrish Type-II, wherein an electronically excited photoinitiator abstracts a hydrogen radical from a further molecule to form a free radical from said further molecule, said free radical acting to initiate the radical polymerisation. Whilst Type-II photoinitiators require the presence of certain additives/co-initiators, these additives/co-initiators are not generally required for Type-I photoinitiators.

The development of new Type-I photoinitiators is a key area of research in the field of resin curing. In addition to the provision of novel Type-I photoinitiators, the provision of Type-I photoinitiator packages, wherein the activity of the Type-I photoinitiator is enhanced by the presence of other compounds, such as photosensitizers. These compounds absorb light at a different wavelength to that of the photoinitiator itself and transfer energy to the photoinitiator, improving the energy absorption by the photoinitiator.

Phosphine oxides are a well-known family of Type-I photoinitiators that provide excellent activity due to the highly reactive phosphinoyl radical formed upon fragmentation. Whist excellent photoinitiators in deep-cure systems, they are notoriously much less effective at achieving surface curing. As such, blends of phosphine oxide photoinitiators with other photoinitiators known to be more effective at surface curing are often used to ensure a thorough cure.

How well different Type-I photoinitiators interact with sensitizers is difficult to predict and often depends on the structure and energy levels of the photoinitiator. The provision of highly active photoinitiator packages is desirous as improved photopolymerization may be achieved without the need to develop new photoinitiators.

Furthermore, although the combination of Type-I photoinitiators with sensitizers as a concept is well established, the provision of further additives that enhance the activity of the photoinitiator package yet further would be most beneficial.

### SUMMARY OF THE INVENTION

The present observation is based on the observation that the effect of certain sensitizers may be enhanced by the presence of amines, leading to even further improvements in photoinitiator ability.

The present invention, in a first aspect, is thus directed to a photoinitiator package comprising:
a) one or more mono- or bisacylphosphine oxide photoinitiators,
b) one or more coumarin-based sensitizers, each having a structure according to formula (I):

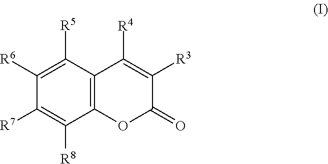

wherein R³ is selected from the group consisting of hydrogen, C₁-C₁₀ alkyl, C₆-C₁₄ aryl, and heteroaryl, R⁴ is selected from the group consisting of hydrogen, C₁-C₁₀ alkyl, wherein said C₁-C₁₀ alkyl may be substituted by one or more fluorine atoms, and OR¹, and each of R⁵ to R⁸ is independently selected from the group consisting of hydrogen, halogen, C₁-C₁₀ alkyl, OR¹, and NR²₂;
wherein each instance of R¹ is independently selected from hydrogen, C₁-C₁₀ alkyl and C₆-C₁₄ aryl, and each instance of R² is independently selected from hydrogen, C₁-C₁₀ alkyl and C₆-C₁₄ aryl, wherein each instance of R¹ to R⁸ may optionally be joined to one or more further instances of R¹ to R⁸ to form one or more 5-membered or 6-membered rings, and
c) one or more amines.

In a second aspect, the present invention is directed to a photopolymerizable composition, comprising:
a) one or more ethylenically unsaturated, free-radical polymerizable compounds;
b) the photoinitiator package according to the first aspect.

In a third aspect, the present invention is directed to a method for photocuring photopolymerizable compositions, coatings, adhesives and inks, said method comprising the following steps in the given order:
a) coating or printing the photopolymerizable composition according to the second aspect onto a substrate, and
b) photopolymerizing said coated or printed composition with a light source on said substrate.

In a fourth aspect, the present invention is directed to a use of the photoinitiator package according to the first aspect in the production of printing inks, screen-printing inks, gravure printing inks, solder masks, etch offset-printing inks, flexographic-printing inks, gravure printing inks, ink jet inks, resist material, insulators, encapsulants, image-recording material, solder mask, passivation layer, protective coating, 3D-printing objects and molds, holographic applications, optical fiber coating, waveguide and lens, overprint varnish, wood, vinyl, metal and plastic coatings.

In a final aspect, the present invention is directed to a use of a combination of one or more amines and one or more coumarin-based sensitizers for increasing the rate of surface curing in photopolymerizable compositions comprising one or more Norrish Type-I photoinitiators.

### Definitions

In the present description the expressions “alkyl” or “alkyl group” mean, where not differently indicated, a linear or branched, saturated alkyl chain containing the given number of carbon atoms and includes all possibilities for each number of carbon atoms in the alkyl group, i.e. for three carbon atoms: n-propyl and i-propyl; for four carbon atoms: n-butyl, i-butyl, s-butyl and t-butyl etc.

The expressions “aryl” or “aryl group” include, for example, a substituted or unsubstituted aryl group (i.e. aromatic carbocyclic ring system), such as a substituted or unsubstituted phenyl group, a substituted or unsubstituted naphthyl group, an anthracenyl group, an indenyl group, a fluorenyl group.

The expressions “heteroaryl” or “heteroaryl group” include, for example, a substituted or unsubstituted heteroatom-containing aromatic ring system, such as pyridine, pyrrole, furan, triazine, indole, quinolone, thiophene etc.

The expression “C₁-C₄₀ alkyl which is interrupted by one or more oxygens” means that, in case more than one oxygen atom is present, said oxygen atoms are separated from one another by at least one methylene group, i.e. the oxygen atoms are non-consecutive. Examples include the following: —OCH₂OCH₃, —OCH₂CH₂OCH₂CH₃, —O[CH₂CH₂O]˜CH₃, —O[CH₂CH₂O]˜OH, —O[CH₂CH₂O]˜CH₂CH₃, —CH₂O[CH₂CH₂O]˜CH₃ with v=1-19, —O[CH₂CH₂CH₂O]ₚOH, —O[CH₂CH₂CH₂O]ₚCH₃, —O[CH₂CH₂CH₂O]ₚCH₂CH₃, —CH₂O[CH₂CH₂CH₂O]ₚCH₃ with p=1-12.

When a group is substituted, the term “substituted” means that said group bears one or more substituents, said substituents being preferably selected from halogen atom, alkyl, cycloalkyl, alkoxy, alkylamino, dialkylamino, alkylthio or arylthio group, heterocyclic groups; more preferably selected from methyl, ethyl, isopropyl, tert-butyl, phenyl, trifluoromethyl, cyano, acetyl, ethoxycarbonyl, carboxyl, carboxylate, amino, methylamino, dimethylamino, ethylamino, diethylamino, isopropylamino, diisopropylamino, cyclohexylamino, dicyclohexylamino, acetylamino, piperidino, pyrrolidyl, methoxy, ethoxy, propoxy, isopropoxy, butoxy, pentyloxy, phenoxy, hydroxyl, acetoxy, —PO₃H, methylthio, ethylthio, i-propylthio, n-propylthio, phenyltio, mercapto, acetylthio, thiocyano, methylsulfinyl, methylsulfonyl, dimethylsulfonyl, sulfonate groups, fluorine atom, chlorine atom, bromine atom, iodine atom, trimethylsilyl, pentamethyldisilyl, triethylsilyl, trimethylstannyl, furyl, thienyl, pyridyl and morpholino.

The expression “a direct bond” means that a linking group is not present, and a direct bond links the two moieties on either side.

A methylene group refers to an sp³ hybridised carbon connected to two hydrogen groups, i.e. —CH₂R, whilst a methanetriyl group refers to an sp³ hybridised carbon connected to one hydrogen group, i.e. —CHR₂.

Photoinitiators may be classed as either Norrish Type-I, wherein an electronically excited photoinitiator fractures to form a free radical that acts to initiate the radical polymerisation, or Norrish Type-II, wherein an electronically excited photoinitiator abstracts a hydrogen radical from a further molecule to form a free radical from said further molecule, said free radical acting to initiate the radical polymerisation, as is well understood by the person skilled in the art.

### DETAILED DESCRIPTION

### Mono- or Bisacylphosphine Oxide Photoinitiator(s)

One of the essential features of the photoinitiator package according to the present invention is one or more mono- or bisacylphosphine oxide photoinitiators.

In the broadest sense, any mono- or bisacylphosphine oxide photoinitiator may be used.

Suitable monoacylphosphine oxide photoinitiators include photoinitiators include, for example, 2,4,6-trimethylbenzoyl-diphenyl phosphine oxide and ethyl (2,4,6-trimethylbenzoyl) phenylphosphinate, Phenyl(2,4,6-trimethylbenzoyl)phosphinic acid, glycerol ethoxylated trimester (Omnipol® TP from IGM Resins B.V.) or those described in US2017/0240659 and Speedcure XKM (from Lambson).

It is, however, preferred that one or more bisacylphosphine oxide photoinitiators are used.

In the broadest sense, any mono- or bisacylphosphine oxide photoinitiator may be used; however, it is preferred that at least one, preferably all, of the one or more bisacylphosphine oxide photoinitiators has a structure according to any one of formulae (II) to (V).

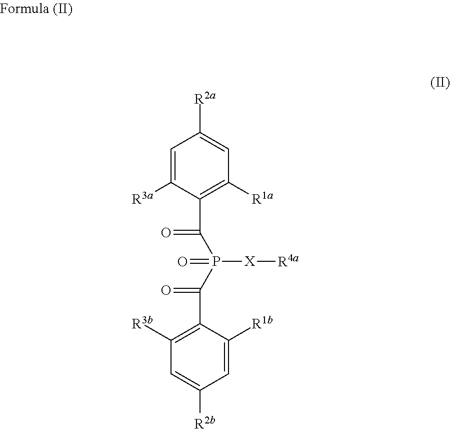

wherein each instance of R^{1a}, R^{2a}, R^{3a}, R^{1b}, R^{2b} and R^{3b} is independently selected from the group consisting of C₁-C₄ alkyl, C₁-C₄ alkoxy or halogen;
wherein X is selected from the group consisting of direct single bond, O, S, NR^{5a}, —CH₂CO₂— and —CH₂CH₂CO₂—;
wherein R^{4a} is selected from the group consisting of hydrogen, (CO)R^{6a}, (CO)OR^{6a}(CO)NR^{5a}R^{6a}, (SO₂)R^{6a}, [Si(R^{7a})(R^{8a})]ₘ—Si(R^{7a})(R^{8a})(R^{9a}), [Si(R^{7a})(R^{8a})O]ₘ—Si(R^{7a})(R^{8a})(R^{9a}); or
wherein R^{4a} is C₁-C₂₈ alkyl or C₂-C₂₈ alkyl which is interrupted by one or more O, NR^{5a}, (CO), (CO)O, or SO₂, wherein said C₁-C₂₈ alkyl or interrupted C₂-C₂₈ alkyl is unsubstituted or substituted by one or more substituents selected from the group consisting of OH, C₆-C₁₄ aryl, [Si(R^{7a})(R^{8a})]ₘ—Si(R^{7a})(R^{8a})(R^{9a}), [Si(R^{7a})(R^{8a})—O]ₘ—Si(R^{7a})(R^{8a})(R^{9a}), N(R^{8a})₂, 2-oxiranyl, C₃-C₁₂ cycloalkyl which is unsubstituted or substituted by C₁-C₄ alkyl, C₁-C₄ alkoxy or by OH, C₃-C₁₂ cycloalkyl which is interrupted by one or more O, NR^{5a} or S and which interrupted C₃-C₁₂ cycloalkyl is unsubstituted or substituted by C₁-C₄ alkyl, C₁-C₄ alkoxy or by OH, and C₆-C₁₄ aryl which is unsubstituted or substituted by C₁-C₄alkyl, C₁-C₄ alkoxy or by OH; or
wherein R^{4a} is C₆-C₁₀ aryl which is unsubstituted or substituted by one or more C₁-C₁₂ alkyl, C₂-C₂₀ alkyl which is interrupted by one or more O, C₁-C₁₂-alkoxy or by OH; or wherein, in cases where X is NR^{5a}, R^{4a} together with R^{5a} and the N-atom forms a 5 or 6-membered saturated ring which is uninterrupted or interrupted by O or NR^{5a} and which uninterrupted or interrupted ring is unsubstituted or substituted by one or more C₁-C₄alkyl, C₁-C₄ alkoxy or by OH; or
wherein R^{4a} is selected from the group consisting of structures (A) to (G):

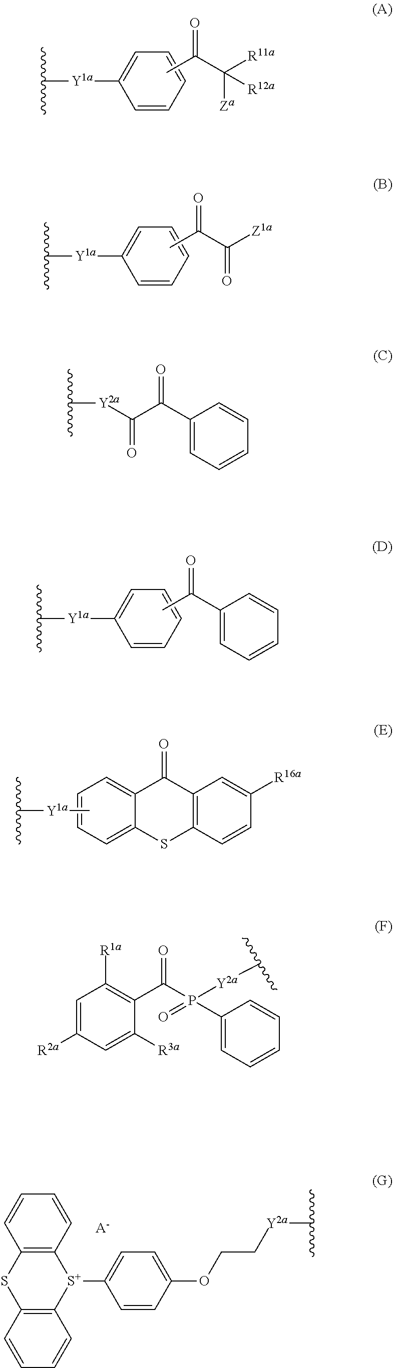

wherein all options for R^{4a} may be further substituted by one or more groups, selected from OH and R^{17a};
wherein R^{17a} is

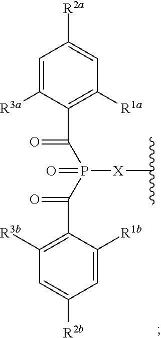

wherein A is PF₆, SbF₆, AsF₆ or B(C₆F₅)₄;
wherein R^{5a} is hydrogen, (CO)R^{6a}, phenyl, C₁-C₁₂ alkyl, C₂-C₁₂ alkyl which is interrupted by one or more O, wherein said C₁-C₁₂ alkyl or interrupted C₂-C₁₂ alkyl is unsubstituted or substituted by one or more C₃-C₇ cycloalkyl, OH or by NCO, C₃-C₁₂ cycloalkyl which is unsubstituted or substituted by one or more C₁-C₄ alkyl, C₁-C₄ alkoxy, OH or by NCO;
wherein R^{6a} is C₁-C₁₂ alkyl or C₂-C₁₂alkyl which is interrupted by one or more O, wherein said C₁-C₁₂ alkyl or interrupted C₂-C₁₂ alkyl is unsubstituted or substituted by one or more C₃-C₇ cycloalkyl, OH, NCO or by phenyl which is substituted by NCO; or
wherein R^{6a} is C₃-C₁₂ cycloalkyl or C₂-C₁₀ alkenyl which is unsubstituted or substituted by one or more C₁-C₄ alkyl, OH or C₁-C₄ alkoxy; or
wherein R^{6a} is C₆-C₁₄ aryl which is unsubstituted or substituted by C₁-C₁₂ alkyl, C₁-C₁₂ alkoxy, NCO or by NCO-substituted C₁-C₁₂ alkyl; or
wherein if the group N(R^{5a})₂ is present, then one instance of R^{5a} may be (CO)R^{6a}, wherein the other instance of R^{5a} and R^{6a}, together with the N and CO moieties form a 5- or 6-membered ring, which is either uninterrupted or interrupted by O or NR^{5a} and which uninterrupted or interrupted ring is either unsubstituted or substituted by one or more C₁-C₄ alkyl, C₁-C₄ alkoxy, or by OH;
wherein R^{7a}, R^{8a}, and R^{9a} are each independently selected from the group consisting of C₁-C₄ alkyl, C₆-C₁₄ aryl or C₁-C₄ alkoxy;
wherein m is an integer in the range from 0-10;
wherein Y^{1a} is selected from the group consisting of a direct single bond, O, S, NR^{5a} O(CO)—* or O(CO)CH₂O—*, wherein the asterix denotes the bond to the phenyl ring of the group (A), (B), (D), or (E);
wherein Y^{2a} is selected from the group consisting of a direct single bond, O, S or NR^{5a};
wherein R^{11a} and R^{12a} independently of each other are C₁-C₁₀alkyl, C₂-C₁₀ alkenyl or phenyl, C₁-C₄ alkyl which is unsubstituted or substituted by C₁-C₄ alkyl, or R^{11a} and R^{12a} together with the C-atom to which they are attached form a cyclohexane or cyclopentane ring;
wherein Z^{a} is OH or NR^{13a}R^{14a};
wherein Z^{1a} is C₁-C₁₂ alkoxy or C₂-C₁₂ alkoxy which is interrupted by one or more O, wherein said C₁-C₁₂ alkoxy or interrupted C₂-C₁₂ alkoxy is unsubstituted or substituted by OH;
wherein R^{13a} and R^{14a} independently of each other are C₁-C₁₂ alkyl, C₁-C₁₂ alkyl which is substituted by one or more OH or halogen; or
wherein R^{13a} and R^{14a} together with the N-atom to which they are attached form a 5- or 6-membered unsaturated or saturated ring, which ring is uninterrupted or interrupted by O or NR^{1a}, wherein R^{11a} is C₁-C₄ alkyl;
wherein R^{16a} is hydrogen or C₁-C₄ alkyl; provided that
(i) if R^{1a}, R^{2a} and R^{3a} as C₁-C₄ alkyl are methyl and X is O, then R⁴ as C₁-C₂₈ alkyl is not methyl, ethyl, n-propyl, 2-propyl, n-butyl, sec-butyl, tert-butyl, n-hexyl;
(ii) if R^{1a} and R^{3a} as halogen are Cl, R^{2a} is hydrogen and X is O, then R^{4a} as substituted C₃-C₁₀ aryl is not 4-butyl-phenyl; and
(iii) if R^{1a} and R^{3a} as C₁-C₄ alkoxy are methoxy, R^{2a} is hydrogen and X is NR^{5a}, and R^{4a} together with R^{5a} and the N-atom forms a 5 or 6-membered saturated ring, then said ring is not a piperidine ring.
Formula (III):

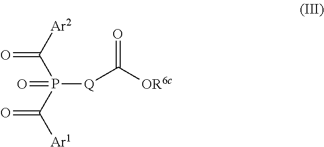

wherein Ar¹ and Ar² are each independently

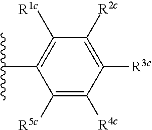

or naphthyl which is unsubstituted or substituted one or more times by R^{1c}, R^{2c}, R^{3c}, R^{4c}, or R^{5c};
wherein R^{1c} and R^{5c} are each independently selected from the group consisting of C₁-C₄ alkyl, C₁-C₄ alkoxy or halogen;
wherein R^{3c} is selected from the group consisting of hydrogen, C₁-C₄ alkyl, halogen, C₁-C₄ alkoxy or C₂-C₂₀ alkoxy which is interrupted by one or more O;
wherein Q is C₁-C₄ alkylene;
wherein R^{2c} and R^{4c} independently of each other are hydrogen or PG^{c}-Y^{c}—Z^{c}—X^{c}—;
wherein PG^{c} is a polymerizable group or methyl or ethyl;
wherein Y^{c} is a direct single bond, O or S;
wherein X^{c} is a direct single bond, O or S;
wherein Z^{c} is a direct single bond, C₁-C₂₀ alkylene or C₂-C₂₀ alkylene which is interrupted by one or more O;
wherein R^{6c} is C₃-C₃₀ alkyl which is unsubstituted or substituted by one or more of the groups selected from OH and Ar¹

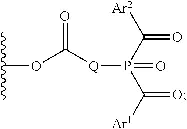

or
wherein R^{6c} is C₃-C₂₈ alkyl which is interrupted by one or more O or C₃-C₈ cycloalkylene and which interrupted C₃-C₂₈ alkyl is unsubstituted or substituted by one or more of the groups selected from OH and

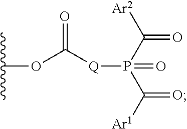

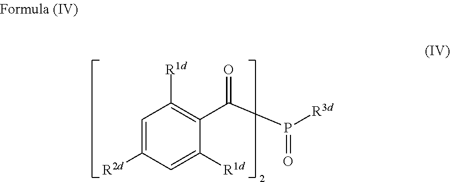

wherein R^{1d} is C₁-C₄ alkyl, C₁-C₄ alkoxy or halogen;
wherein R^{2d} is hydrogen, C₁-C₄ alkyl, C₁-C₄ alkoxy or halogen; and
wherein R^{3d} is C₁-C₂₀alkyl, cyclopentyl, cyclohexyl, phenyl-C₁-C₄ alkyl, naphthyl, biphenylyl or an O-, S- or N-containing 5- or 6-membered heterocyclic ring, the naphthyl, biphenylyl and O-, S- or N-containing 5- or 6-membered heterocyclic ring radicals being unsubstituted or substituted by C₁-C₄ alkyl, C₁-C₄ alkoxy, halogen, C₁-C₄ alkylthio; or
wherein R^{3d} is

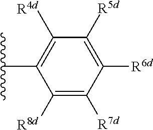

wherein R^{4d}, R^{5d}, R^{6d}, R^{7d} and R^{8d} are each independently selected from the group consisting of hydrogen, halogen, C₁-C₂₀ alkyl, cyclopentyl, cyclohexyl, C₂-C₁₂ alkenyl, C₂-C₂₀alkyl interrupted by one or more non-consecutive O atoms, phenyl-C₁-C₄ alkyl, C₁-C₂₀ alkoxy, or phenyl that is unsubstituted or substituted by one or two C₁-C₄ alkyl or/and C₁-C₄ alkoxy substituents.

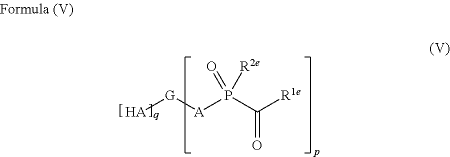

wherein each A represents independently of one another O, S, NR³;
wherein G is a residue of the multifunctional compound (core) G-(A-H)_{p+q}, wherein each A-H represents an alcoholic or amino or thiol group;
wherein p and q are both integer numbers, p+q is an integer in the range from 3 to 10, and p is an integer in the range from 3 to 8;
wherein R^{1e} and R^{2e} are each independently selected from the group consisting of C₁-C₁₈ alkyl, C₆-C₁₂ aryl and C₅-C₁₂ cycloalkyl, each of which is uninterrupted or interrupted by one or more oxygen and/or sulfur atoms and/or one or more substituted or unsubstituted amino groups, or are a five- to six-membered heterocyclyl containing oxygen and/or nitrogen and/or sulfur atoms; where each of said groups may be substituted by aryl, alkyl, aryloxy, alkoxy, heteroatoms and/or heterocyclic radicals; R^{2e} may also be (CO)R^{1e};
wherein R^{3c} is hydrogen or C₁-C₄ alkyl.

In one embodiment, at least one of the one or more bisacylphosphine oxide photoinitiators each have a structure according to formula (VI):

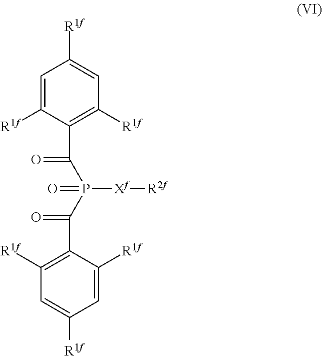

wherein each instance of R^{1f} is independently selected from the group consisting of C₁-C₄ alkyl;
wherein X^{f} is selected from the group consisting of direct single bond, O, S, NR^{4f}, —CH₂CO₂—, and
—CH₂CH₂CO₂—;
wherein R^{2f} is selected from the group consisting of C₁-C₄₀ alkyl and interrupted C₂-C₄₀ alkyl being interrupted by one or more O or C₃-C₅ cycloalkylene, wherein said C₁-C₄₀ alkyl or interrupted C₂-C₄₀ alkyl may be unsubstituted or substituted by one or more groups selected from OH and R^{3f};
wherein R^{3f} is

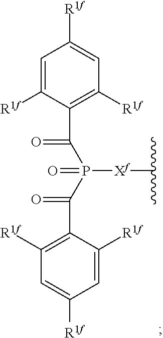

wherein R^{4f} is selected from the group consisting of hydrogen, (CO)R^{5f}, phenyl, C₁-C₁₂ alkyl, C₂-C₁₂ alkyl being interrupted by one or more O, wherein said C₁-C₁₂ alkyl or interrupted C₂-C₁₂ alkyl is unsubstituted or substituted by one or more C₃-C₇ cycloalkyl, OH or by NCO, C₃-C₁₂ cycloalkyl which is unsubstituted or substituted by one or more C₁-C₄ alkyl, C₁-C₄ alkoxy, OH or by NCO; and
wherein R^{5f} is selected from the group consisting of C₁-C₁₂ alkyl or C₂-C₁₂ alkyl which is interrupted by one or more O, wherein said C₁-C₁₂ alkyl or interrupted C₂-C₁₂ alkyl is unsubstituted or substituted by one or more C₃-C₇-cycloalkyl, OH, NCO or by phenyl which is substituted by NCO; C₃-C₁₂ cycloalkyl; C₂-C₁₀ alkenyl which is unsubstituted or substituted by one or more C₁-C₄ alkyl, OH or C₁-C₄ alkoxy; C₆-C₁₄ aryl which is unsubstituted or substituted by C₁-C₁₂ alkyl, C₁-C₁₂ alkoxy, NCO or by NCO-substituted C₁-C₁₂ alkyl.

Each instance of R^{f} may be independently selected from the group consisting of C₁-C₄ alkyl, i.e. from methyl, ethyl, n-propyl, i-propyl, n-butyl, s-butyl, i-butyl and t-butyl. It is particularly preferred that each instance of R^{f} is selected from methyl and ethyl. Most preferably, each instance of R^{f} is methyl.

X^{f} is selected from the group consisting of direct single bond, O, S, NR^{3f}, —CH₂CO₂—, and —CH₂CH₂CO₂—. More preferably, X^{f} is selected from the group consisting of direct single bond, O, —CH₂CO₂—, and —CH₂CH₂CO₂—. Yet more preferably, X^{f} is selected from the group consisting of direct single bond —CH₂CO₂—, and —CH₂CH₂CO₂—. Most preferably X^{f} is a direct single bond.

R^{1f} is selected from the group consisting of C₁-C₄₀ alkyl and interrupted C₂-C₄₀ alkyl being interrupted by one or more O or C₃-C₅ cycloalkylene, wherein said C₁-C₄₀ alkyl or interrupted C₂-C₄₀ alkyl may be unsubstituted or substituted by one or more groups selected from OH and R^{3f};
wherein R^{3f} is

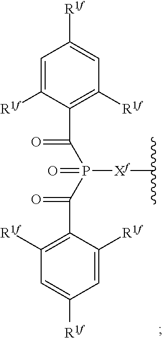

In some embodiments no R^{3f} is present, meaning that the structure according to Formula (VI) has a single bisacylphosphine oxide moiety.

In such embodiments, it is preferred that R^{2f} is selected from the group consisting of C₁-C₂₀ alkyl, —(CH₂CH₂O—)ₙCH₃, and —(CH₂CH₂O—)ₙH, wherein n is an integer in the range from 1 to 20.

It is particularly preferred that R^{2f} is C₁-C₂₀ alkyl.

Especially preferred are embodiments wherein X^{f} is single direct bond and R² is C₁-C₂₀ alkyl. It is particularly preferred in such embodiments that each instance of R^{f} is methyl.

Similarly, embodiments wherein X^{f} is O and R^{2f} is —(CH₂CH₂O—)ₙCH₃ or —(CH₂CH₂O—)ₙH are also especially preferred. It is particularly preferred in such embodiments that each instance of R^{f} is methyl.

In other embodiments, at least one instance of R^{3f} is present, meaning that the structure according to Formula (VI) has more than one bisacylphosphine oxide moiety.

Such embodiments are preferably described by Formula (VI) wherein R^{1f} has a structure according to formula (VII):

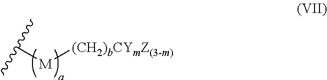

wherein each instance of M is independently selected from (CH₂CH₂O) and (CH₂CH(CH₃)O);
wherein each instance of Y is independently selected from hydrogen and C₁-C₄ alkyl;
wherein each instance of Z has the structure CH₂(M¹)_{c}R^{2f};
wherein each instance of M¹ is independently selected from (OCH₂CH₂) and (OCH(CH₃)CH₂)
wherein a is an integer in the range from 0 to 15;
wherein b is an integer in the range from 0 to 6;
wherein each instance of c is independently an integer in the range from 0 to 15;
wherein m is an integer in the range from 0 to 2; and
wherein each instance of X^{f} is independently selected from the group consisting of —CH₂CO₂—, and
—CH₂CH₂CO₂—.

Such structures are typically formed by combining a central polyol core with multiple BAPO-based carboxylic acid residues, wherein ethylene glycol/propylene glycol spacers (i.e. units M and M¹) are optionally used to separate the central polyol core from the BAPO-based carboxylic acid residues.

Suitable polyol cores include glycerol, wherein b=0, m=1 and Y=H, trimethylolpropane, wherein b=1, m=1 and Y=ethyl, pentaerythritol, wherein b=1, m=0, neopentyl glycol, wherein b=1 m=2 and both instances of Y=methyl, ethylene glycol, wherein b=0, m=2, and both instances of Y=H; 1,6-hexanediol, wherein b=4, m=2 and both instances of Y═H.

Other suitable polyols include propylene glycol, 1,2-butanediol, 1,3-butanediol, 1,4-butanediol, 2,3-butanediol, 1,2-hexanediol, 1,5-hexanediol, 2,5-hexanediol. The skilled person would be aware of which values of b and m as well as choice of Y correspond to these polyols.

Particularly preferred polyol cores are glycerol, wherein b=0, m=1 and Y=H, trimethylolpropane, wherein b=1, m=1 and Y=ethyl, pentaerythritol, wherein b=1, m=0.

When a gylcerol core is used, R^{2f} is termed “optionally ethoxylated/propoxylated glycerol”.

When a trimethylolpropane core is used, R^{2f} is termed “optionally ethoxylated/propoxylated trimethylolpropane”.

When a pentaerythritol core is used, R^{2f} is termed “optionally ethoxylated/propoxylated pentaerythritol”.

When a neopentyl glycol core is used, R^{2f} is termed “optionally ethoxylated/propoxylated neopentyl glycol”.

When an ethylene glycol core is used, R^{2f} is termed “optionally ethoxylated/propoxylated ethylene glycol”.

When a 1,6-hexanediol core is used, R^{2f} is termed “optionally ethoxylated/propoxylated 1,6-hexanediol”.

It is particularly preferred that a is an integer in the range from 1 to 15 and each instance of c is an integer in the range from 1 to 15, wherein the sum of a and each instance of c is in the range from 3 to 20, more preferably in the range from 3 to 15, most preferably in the range from 3 to 10.

Such embodiments are termed “ethoxylated/propoxylated polyol”, wherein polyol may be glycerol, trimethylolpropane, pentaerythritol, neopentyl glycol, ethylene glycol or 1,6-hexanediol.

It is particularly preferred that R^{2f} is selected from the group consisting of C₁-C₂₀ alkyl, —(CH₂CH₂O—)ₙCH₃, and —(CH₂CH₂O—)ₙH, wherein n is an integer in the range from 1 to 20, ethoxylated/propoxylated glycerol, ethoxylated/propoxylated trimethylolpropane, and ethoxylated/propoxylated pentaerythritol.

When R^{2f} is a C₁-C₂₀alkyl, it is particularly preferred that R^{2f} is a C₁-C₁₅ alkyl, more preferably a C₁-C₁₂ alkyl.

It is particularly preferred that each of the one or more bisacylphosphine oxide photoinitiators each have a structure according to formula (VI)

In alternative embodiment, at least one of the one or more bisacylphosphine oxide photoinitiators each have a structure according to formula (VI), wherein each instance of R^{f} is independently selected from the group consisting of C₁-C₄ alkyl, X^{f} is a direct single bond and R^{2f} is selected from the group consisting of C₆-C₁₄ aryl, C₁-C₂₀ alkyl, —(CH₂CH₂O—)ₙCH₃, and —(CH₂CH₂O—)ₙH, wherein n is an integer in the range from 1 to 20.

More preferably, R^{2f} is selected from C₆-C₁₄ aryl, most preferably is phenyl.

In one particularly preferred embodiment, each instance of R^{f} is methyl, X^{f} is a direct single bond and R^{2f} is phenyl.

### Coumarin-Based Sensitizers

Another essential feature of the photoinitiator package according to the present invention is the presence of one or more coumarin-based sensitizers, each having a structure according to formula (I)

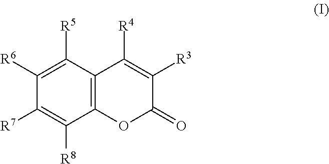

wherein R³ is selected from the group consisting of hydrogen, C₁-C₁₀ alkyl, C₆-C₁₄ aryl, and heteroaryl,
R⁴ is selected from the group consisting of hydrogen, C₁-C₁₀ alkyl, and OR¹, and each of R⁵ to R⁸ is independently selected from the group consisting of hydrogen, halogen, alkyl, OR¹, and NR²₂;
wherein each instance of R¹ is selected from hydrogen, C₁-C₁₀ alkyl and C₆-C₁₄ aryl, and each instance of R² is selected from hydrogen, C₁-C₁₀ alkyl and C₆-C₁₄ aryl, wherein each instance of R¹ to R⁸ may optionally be joined to one or more further instances of R¹ to R⁸ to form one or more 5-membered or 6-membered rings.

In one preferred embodiment, R³ is selected from the group consisting of hydrogen and C₁-C₁₀ alkyl, or R⁴ is selected from the group consisting of hydrogen and C₁-C₁₀ alkyl.

In another preferred embodiment, R³ is selected from the group consisting of hydrogen and C₁-C₁₀ alkyl, and R⁴ is selected from the group consisting of hydrogen and C₁-C₁₀ alkyl.

In another preferred embodiment, R⁷ is selected from the group consisting of OR¹, and NR²₂, most preferably R⁷ is NR²₂.

In a particularly preferred embodiment, R³ is selected from the group consisting of hydrogen and C₁-C₁₀ alkyl or R⁴ is selected from the group consisting of hydrogen and C₁-C₁₀ alkyl, whilst R⁷ is selected from the group consisting of OR¹, and NR²₂, most preferably R⁷ is NR²₂.

In an especially preferred embodiment, R³ is selected from the group consisting of hydrogen and C₁-C₁₀ alkyl, R⁴ is selected from the group consisting of hydrogen and C₁-C₁₀ alkyl, and R⁷ is selected from the group consisting of OR¹, and NR²₂, most preferably R⁷ is NR²₂.

At least one of, preferably all of, the coumarin-based sensitizers are selected from the group consisting of coumarin, 7-amino-4-(trifluoromethyl)coumarin, 3-(2-benzothiazolyl)-7-(diethylamino)coumarin, 7-hydroxy-4-(trifluoromethyl)coumarin, 7-(ethylamino)-4,6-dimethylcoumarin, 7-methoxy-4-(trifluoromethyl)coumarin, 7-ethoxy-4-(trifluoromethyl)coumarin, 7-amino-4-methylcoumarin, 7-(diethylamino)-4-methylcoumarin, 3-(2-benzoxazolyl)-7-(diethylamino)coumarin, 7-methylcoumarin, 7-methoxycoumarin, 4-hydroxycoumarin, 5,7-dimethoxycoumarin, 3-(3-biphenyl-4-yl-1,2,3,4-tetrahydro-1-naphthyl)-4-hydroxycoumarin, 6-methylcoumarin, 3-chloro-7-hydroxy-4-methylcoumarin, 7-hydroxycoumarin, 7-hydroxy-6-methoxycoumarin, 7-methoxy-6-hydroxycoumarin, 6-hydroxycoumarin, 7,8-dihydroxy-4-methylcoumarin, 7-Hydroxy-4-methylcoumarin, 7-(dimethylamino)-4-methylcoumarin, 2,3,6,7-Tetrahydro-9-methyl-1H,5H,11H-benzopyrano[6,7,8-ij]quinolizin-11-one, 7-(diethylamino)-4-(trifluoromethyl)-coumarin, and 7-(ethylamino)-4-(trifluoromethyl)coumarin.

More preferably, at least one of, preferably all of, of the coumarin-based sensitizers are selected from the group consisting of coumarin, 3-(2-benzothiazolyl)-7-(diethylamino)coumarin, 7-methoxy-4-(trifluoromethyl)coumarin, 7-ethoxy-4-(trifluoromethyl)coumarin, 7-(diethylamino)-4-methylcoumarin, 3-(2-benzoxazolyl)-7-(diethylamino)coumarin, 7-methylcoumarin, 7-methoxycoumarin, 5,7-dimethoxycoumarin, 6-methylcoumarin, 7-(dimethylamino)-4-methylcoumarin, 2,3,6,7-Tetrahydro-9-methyl-1H,5H,11H-[1]benzopyrano[6,7,8-ij]quinolizin-11-one, 7-(diethylamino)-4-(trifluoromethyl)-coumarin, and 7-(ethylamino)-4-(trifluoromethyl)coumarin.

Most preferably, at least one of, preferably all of, of the coumarin-based sensitizers are selected from the group consisting of coumarin, 7-(diethylamino)-4-methylcoumarin, 7-methylcoumarin, 7-methoxycoumarin, 5,7-dimethoxycoumarin, and 7-(diethylamino)-4-(trifluoromethyl)-coumarin.

### Amines

Another essential feature of the photoinitiator package according to the present invention is the presence of one or more amines

It is a finding of the present invention that the presence of amines in Norrish Type-I photoinitiator-based packages, in combination with coumarin-based sensitizers, can drastically improve the rate of curing, in particular surface curing.

In the broadest sense, the one or more amines according to the present invention may be any amine, including aliphatic, cycloaliphatic, aromatic, aryl aliphatic, heterocyclic, oligomeric or polymeric amines. They may be primary, secondary or tertiary amines, for example, butyl amine, dibutylamine, tributylamine, cyclohexyl amine, benzyldimethyl amine, dicyclohexyl amine, N-phenyl glycine, triethyl amine, phenyl-diethanol amine, triethanolamine, piperidine, piperazine, morpholine, quinolone, esters of dimethylamino benzoic acid, and corresponding derivatives. Furthermore, amine-modified acrylates can be used. Examples of such amine-modified acrylates include acrylates modified by reaction with a primary or secondary amine that are 15 described in U.S. Pat. No. 3,844,916, EP 280222, U.S. Pat. No. 5,482,649 or U.S. Pat. No. 5,734,002.

Multifunctional amine and polymeric amine derivatives are also suitable for use are Omnipol ASA from IGM Resins B.V., Genopol AB-2 from Rahn A.G., Speedcure 7040 from Lambson Limited or those described in US2013/0012611.

It would be understood by the person skilled the art that the term “amine” does not include amides or imides, irrespective of whether the nitrogen of the amide/imide is bonded to an alkyl group. Likewise, ammonium salts would not be amines.

It is preferred that the one or more amines are not Type-I or Type-II photoinitiators, such as well-known aminoketone Type-I initiators. It is further preferred that the one or more amines are not optical brighteners, i.e. compounds that absorb light in the ultraviolet and violet region of the EM-spectrum and re-emits the light in the blue region via fluorescence. As such, it is clear that the only role of the amine in the photopolymerization package is to act as a synergist, improving the effect of the one or more one or more mono- or bisacylphosphine oxide photoinitiators and/or the one or more coumarin-based sensitizers.

It is preferred that the one or more amines have a so-called alpha-hydrogen, i.e. a hydrogen bonded to a carbon that is directly bonded to the nitrogen of the amine. It is particularly preferred that this hydrogen is bonded to an sp³-hybridized carbon. As such, it is preferred that the amine has a nitrogen atom having a direct single bond to either a methyl group (i.e. CH₃), a methylene group (i.e. the CH₂ of a CH₂R) or a methanetriyl group (i.e. the CH of a CHR₂).

Without wishing to be bound by theory, it is believed that the alpha-hydrogen may be easily abstracted by radicals, forming a stabilized alpha-amino-radical, which can play a role in improving the rate of curing, in particular by scavenging molecular oxygen, which may retard the polymerization reaction.

It is particularly preferred that the nitrogen atom is bonded to at least one alkyl group. It is further preferred that the nitrogen atom is bounded to at least two alkyl groups.

In one particularly preferred embodiment, the one or more amines are independently selected from the group consisting of amines having the formula NR^{A}R^{B}R^{C}, wherein R^{A} and R^{B} are independently selected from optionally substituted alkyl groups and Re is selected from the group consisting of optionally substituted alkyl groups and optionally substituted aryl groups.

In said embodiment, the term “optionally substituted aryl groups” does not include aryl groups that have two or more substituents that are linked to form a fused ring system, such as a quinoline, an indole, or a coumarin. Likewise, the term “optionally substituted alkyl groups” does not include substitution that would result in the group no longer being considered as an alkyl group, such as acyl groups (i.e. ═O substitution at the first carbon atom of the alkyl chain).

### Photoinitiator Package

The photoinitiator package according to the present invention comprises one or more mono- or bisacylphosphine oxide photoinitiators as described above, one or more coumarin-based sensitizers as described above and one or more amines as described above.

It is preferred that the photoinitiator package comprises, more preferably consists of
a) an amount in the range from 40 to 98.9 wt.-%, more preferably in the range from 60 to 96.0 wt.-%, most preferably in the range from 65 to 92.0 wt.-%, relative to the total weight of the photoinitiator package, of the one or more mono- or bisacylphosphine oxide photoinitiators;
b) an amount in the range from 0.1 to 50 wt.-%, more preferably in the range from 1.0 to 37 wt.-%, most preferably in the range from 3.0 to 30 wt.-%, relative to the total weight of the photoinitiator package, of the one or more coumarin-based sensitizers; and
c) an amount in the range from 1.0 to 45 wt.-%, more preferably in the range from 3.0 to 35 wt.-%, most preferably in the range from 5.0 to 30 wt.-%, relative to the total weight of the photoinitiator package, of one or more amines.

In a further embodiment, the photoinitiator package comprises, more preferably consists of:
a) an amount in the range from 40 to 98.9 wt.-%, relative to the total weight of the photoinitiator package, of the one or more mono- or bisacylphosphine oxide photoinitiators;
b) an amount in the range from 0.1 to 50 wt.-%, relative to the total weight of the photoinitiator package, of the one or more coumarin-based sensitizers; and
c) an amount in the range from 1.0 to 45 wt.-%, relative to the total weight of the photoinitiator package, of one or more amines.

In another embodiment, the photoinitiator package comprises, more preferably consists of:
a) an amount in the range from 60 to 95.0 wt.-%, relative to the total weight of the photoinitiator package, of the one or more mono- or bisacylphosphine oxide photoinitiators;
b) an amount in the range from 1.0 to 37 wt.-%, relative to the total weight of the photoinitiator package, of the one or more coumarin-based sensitizers; and
c) an amount in the range from 3.0 to 35 wt.-%, relative to the total weight of the photoinitiator package, of one or more amines.

In yet a further embodiment, the photoinitiator package comprises, more preferably consists of:
a) an amount in the range from 65 to 92.0 wt.-%, relative to the total weight of the photoinitiator package, of the one or more mono- or bisacylphosphine oxide photoinitiators;
b) an amount in the range from 3.0 to 30 wt.-%, relative to the total weight of the photoinitiator package, of the one or more coumarin-based sensitizers; and
c) an amount in the range from 5.0 to 30 wt.-%, relative to the total weight of the photoinitiator package, of one or more amines.

If further components other than the one or more mono- or bisacylphosphine oxide photoinitiators, the one or more coumarin-based sensitizers and the one or more amines are present, then they are preferably further Type-I photointiators.

It is particularly preferred that the only photoinitiators present in the photoinitiator package are Norrish Type-I photoinitiators or cationic photoinitiators.

It is further preferred that the only photoinitiators present in the photoinitiator package are Norrish Type-I photoinitiators.

Additionally or alternatively, further optical brightener sensitizers may be present.

As would be understood by the person skilled in the art, the term “further optical brightener sensitizers” means that these further sensitizers have structures other than the one or more coumarin-based sensitizers.

As would be understood by the person skilled in the art, the term “sensitizer” in “one or more optical brightener sensitizer” explains the purpose of the optical brightener in the photoinitiator package and does not limit the choice of the optical brightener that may be employed.

Furthermore, the person skilled in the art would be well aware that an optical brightener is a chemical compound that absorbs light in the ultraviolet and violet region of the EM-spectrum and re-emits the light in the blue region via fluorescence.

As such, it is preferred that the photoinitiator package comprises, more preferably consists of the one or more bisacylphosphine oxide photoinitiators, the one or more coumarin-based sensitizers, one or more amines, optionally one or more further Type-I photoinitiators, and optionally one or more further optical brightener sensitizers.

Thus, the photoinitiator package preferably consists of
a) an amount in the range from 40 to 98.9 wt.-%, more preferably in the range from 60 to 96.0 wt.-%, most preferably in the range from 65 to 92.0 wt.-%, relative to the total weight of the photoinitiator package, of the one or more mono- or bisacylphosphine oxide photoinitiators;
b) an amount in the range from 0.1 to 50 wt.-%, more preferably in the range from 1.0 to 37 wt.-%, most preferably in the range from 3.0 to 30 wt.-%, relative to the total weight of the photoinitiator package, of the one or more coumarin-based sensitizers;
c) an amount in the range from 1.0 to 45 wt.-%, more preferably in the range from 3.0 to 35 wt.-%, most preferably in the range from 5.0 to 30 wt.-%, relative to the total weight of the photoinitiator package, of one or more amines;
d) an amount in the range from 0.0 to 58.9 wt.-%, more preferably in the range from 0 to 36.0 wt.-%, most preferably in the range from 0.0 to 27.0 wt.-%, of further Type-I initiators; and
e) an amount in the range from 0.0 to 58.9 wt.-%, more preferably in the range from 0 to 36.0 wt.-%, most preferably in the range from 0.0 to 27.0 wt.-%, of further optical brightener sensitizers.

### Photopolymerizable Composition

In a second aspect, the present invention is also directed to a photopolymerizable composition.

In the broadest sense, the photopolymerizable composition comprises or consist of
a) one or more ethylenically unsaturated, free-radical polymerizable compounds;
b) the photoinitiator package according to the first aspect.

It is preferred that the photopolymerizable composition comprises or consists of:
a) an amount in the range from 30 to 99.0 wt.-%, more preferably in the range from 50 to 95.0 wt.-%, most preferably in the range from 70 to 90 wt.-%, relative to the total weight of the photopolymerizable composition, of the one or more ethylenically unsaturated, free-radical polymerizable compounds;
b) an amount in the range from 0.5 to 50 wt.-%, more preferably in the range from 0.8 to 40 wt.-%, most preferably in the range from 1.0 to 30 wt.-%, relative to the total weight of the photopolymerizable composition, of the photoinitiator package according to the first aspect.

In addition to the one or more ethylenically unsaturated, free-radical polymerizable compounds and photoinitiator package according to the first aspect, the photopolymerizable composition may comprise further components, as would be well-understood by the person skilled in the art.

Suitable further components include photosensitizers, further photoinitiators, pigments, binders, and conventional additives.

As such, the photopolymerizable composition comprises, more preferably consists of
a) an amount in the range from 30 to 99.0 wt.-%, more preferably in the range from 50 to 95.0 wt.-%, most preferably in the range from 70 to 90 wt.-%, relative to the total weight of the photopolymerizable composition, of the one or more ethylenically unsaturated, free-radical polymerizable compounds;
b) an amount in the range from 0.5 to 50 wt.-%, more preferably in the range from 0.8 to 40 wt.-%, most preferably in the range from 1.0 to 30 wt.-%, relative to the total weight of the photopolymerizable composition, of the photoinitiator package according to the first aspect;
c) optionally, an amount in the range from 0.5 to 30 wt.-%, more preferably in the range from 0.8 to 20 wt.-%, most preferably in the range from 1.0 to 15 wt.-% of one or more further photoinitiators, one or more photosensitizers and/or one or more co-initiators;
d) optionally, an amount in the range from 0.1 to 30 wt.-%, more preferably in the range from 1.0 to 25 wt.-%, most preferably in the range from 10 to 20 wt.-%, relative to the total weight of the photopolymerizable composition, of one or more pigments;
e) optionally, an amount in the range from 5.0 to 60 wt.-%, more preferably in the range from 8.0 to 50 wt.-%, most preferably in the range from 10 to 40 wt.-%, relative to the total weight of the photopolymerizable composition, of one or more binders; and
f) optionally, an amount in the range from 0.01 to 10 wt.-%, more preferably in the range from 0.01 to 8.0 wt.-%, most preferably in the range from 0.01 to 5.0 wt.-%, relative to the total weight of the photopolymerizable composition, of one or more additives.

In addition, the photopolymerizable composition may be formulated in compositions further comprising water and/or solvents, such as organic solvents.

It is preferred that no further photoinitiators, photosensitizers or co-initiators are present, beyond those forming part of the photoinitiator package. In other words, all components that contribute to the photopolymerization properties of the photoinitiator are preferably subsumed within the photoinitiator package, as defined above and below.

The choice of the one or more ethylenically unsaturated, free-radical polymerizable compounds is not particularly limited. Said polymerizable compounds can contain one or more olefinic double bonds. They can be low-molecular weight (monomeric) or high-molecular weight (oligomeric) compounds.

Examples of suitable low molecular weight polymerizable compounds (monomeric compounds) having one double bond are alkyl or hydroxyalkyl acrylates or methacrylates, such as methyl-, ethyl-, butyl-, 2-ethylhexyl-,2-hydroxyethyl- or isobornyl-acrylate; and methyl or ethyl methacrylate. Further examples 5 are resins modified with silicon or fluorine, e.g. silicone acrylates. Further examples of these polymerizable compounds are acrylonitrile, acrylamide, methacrylamide, N-substituted (meth)acrylamides, styrene, alkylstyrenes and halogeno styrenes, vinyl esters such as vinyl acetate, vinyl ethers such as iso-butyl vinyl ether, N-vinylpyrrolidone, vinyl chloride or vinylidene chloride.

Examples of polymerizable compounds having more than one double bond are the ethylene glycol diacrylate, propylene glycol diacrylate, neopentyl glycol diacrylate, hexamethylene glycol diacrylate, bisphenol A diacrylate, 4,4′-bis-(2-acryloyloxyethoxy)-diphenylpropane, trimethylolpropane triacrylate, pentaerythritol triacrylate or tetraacrylate, vinyl acrylate, divinyl benzene, divinyl succinate, diallyl phthalate, triallyl phosphate, triallyl isocyanurate or tris-(2-acryloylethyl) isocyanurate.

Examples of high-molecular weight (oligomeric) polyunsaturated compounds are acrylated epoxy resins, acrylated or vinyl-ether- or epoxy-group-containing polyesters, acrylated polyurethanes or acrylated polyethers.

Further examples of unsaturated oligomers are unsaturated polyester resins which are usually prepared from maleic acid, phthalic acid and one or more diols and which have molecular weights of from about 500 Da to 3,000 Da. Such unsaturated oligomers can also be referred to as prepolymers.

Examples of polymerizable compounds which are particularly suitable for the implementation of the present invention, are esters of ethylenically unsaturated carboxylic acids and polyols or polyepoxides, and polymers containing ethylenically unsaturated groups in the chain or in side groups, e.g. unsaturated polyesters, polyamides and polyurethanes and copolymers thereof, alkyl resins, polybutadiene and butadiene copolymers, polyisoprene and isoprene copolymers, polymers and copolymers having (meth)acrylic groups in side chains, as well as mixtures thereof.

Illustrative examples of unsaturated carboxylic acids or anhydrides, useful for the preparation of the above esters, are acrylic acid, methacrylic acid, maleic anhydride, crotonic acid, itaconic acid, cinnamic acid and unsaturated fatty acids such as linolenic acid and oleic acid. Acrylic and methacrylic acid are preferred.

Examples of polyols, which can also be esterified, are aromatic and aliphatic and cycloaliphatic polyols, preferably aliphatic and cycloaliphatic polyols. Aromatic polyols are, for example, hydroquinone, 4,4′-dihydroxydiphenyl, 2,2-di(4-hydroxyphenyl) propane, as well as novolaks and resoles.

Polyepoxides, which can be esterified, include those based on the said polyols, especially the reaction products between aromatic polyols and epichlorohydrin. Also suitable as polyols are polymers and copolymers that contain hydroxyl groups in the polymer chain or in side groups, for example polyvinyl alcohol and copolymers thereof or polymethacrylic acid hydroxyalkyl esters or copolymers thereof. Further suitable polyols are oligoesters carrying hydroxyl terminal groups.

Examples of aliphatic and cycloaliphatic polyols include alkylenediols containing preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 Da to 1,500 Da, 1,3-cyclopentanediol, 1,2-, 1,3- or 1,4-cyclohexanediol, 1,4-dihydroxymethyl cyclohexane, glycerol, tris(β-hydroxy-ethyl)amine, trimethylolethane, trimethylolpropane, pentaerythritol, dipentaerythritol and sorbitol.

Further suitable ethylenically unsaturated compounds are unsaturated polyamides obtained from unsaturated carboxylic acids and aromatic, aliphatic and cycloaliphatic polyamines having preferably from 2 to 6, preferably from 2 to 4, amino groups. Examples of such polyamines are: ethylenediamine, 1,2- or 1,3-propylenediamine, 1,2-, 1,3- or 1,4-butylenediamine, 1,5-pentylenediamine, 1,6-hexylenediamine, octylenediamine, dodecylene diamine, 1,4-diaminocyclohexane, isophoronediamine, phenylene diamine, bisphenylenediamine, di-(β-aminoethyl) ether, diethylene triamine, triethylenetetramine and di(β-aminoethoxy)- and di(β-aminopropoxy)ethane. Other suitable polyamines are polymers and copolymers which may contain additional amino groups in the side chain and oligoamides containing amino end groups.

Specific examples of such unsaturated polyamides are methylenebisacrylamide, 1,6-hexamethylene bisacrylamide, diethylenetriamine trismethacrylamide, bis(methacrylamidopropoxy) ethane and N-[(β-hydroxyethoxy)ethyl]-acrylamide.

Unsaturated polyurethanes are also suitable for the implementation of the present invention as polymerizable compounds, for example those derived from saturated or unsaturated diisocyanates and unsaturated or saturated diols.

Polybutadiene and polyisoprene and copolymers thereof may also be used.

Suitable polymerizable compounds include, for example, olefins, such as ethylene, propene, butene and hexene, (meth)acrylates, acrylonitrile, styrene and vinyl chloride. Polymers having unsaturated (meth)acrylate groups in the side chain can also be used as the one or more ethylenically unsaturated, free-radical polymerizable compounds. They may typically be reaction products of epoxy resins based on novolac with (meth)acrylic acid; homo- or copolymers of vinyl alcohol or hydroxyalkyl derivatives thereof that have been esterified with (meth)acrylic acid; and homo- and co-polymers of (meth)acrylates that have been esterified with hydroxyalkyl (meth)acrylates.

Examples of photosensitizers are those commonly used in the art, terphenyls, styryl ketones, and 3-(aroylmethylene)-thiazolines, and also eosin, rhodamine and erythrosine dyes.

It was observed that the above photosensitizers increase the activity of the one or more bisacylphosphine oxide photoinitiators without shortening the shelf life of the compositions. Moreover, such compositions have the special advantage that an appropriate choice of the photosensitizer allows the spectral sensitivity of the photoinitiator package to be shifted to any desired wavelength region. The person skilled in the art is able to select the suitable photosensitizer to make the photoinitiator package work at any desired wavelength region.

Examples of other suitable photoinitiators are acetophenone, acetophenone derivatives, dialkoxyacetophenones, α-hydroxyketones, α-aminoketones, benzoin alkyl ethers and benzil ketals, e.g. benzil dimethyl ketal, acylphosphine photoinitiators (which can be chosen among mono-acylphosphine oxides, bis-acylphosphine oxides, tris-acylphosphine oxides and multifunctional mono- or bisacylphosphine oxides), halomethyltriazines, hexaaryl bisimidazole/coinitiator systems, e.g. ortho-chlorohexaphenylbisimidazole in combination with 2-mercaptobenzothiazole, ferrocenium compounds or titanocenes, for example dicyclopentadienyl-bis(2,6-difluoro-3-pyrrolo-phenyl)titanium, O-acyloxime ester photoinitiators.

Examples of α-hydroxyketones and α-aminoketones are 1-hydroxy cyclohexylphenyl ketone, 2-hydroxy-2-methyl-1-phenyl-propane-1-one, 1-[4-(2-hydroxyethoxy)phenyl]-2-hydroxy-2-methyl-1-propane-1-one, 2-hydroxy-1-{4-[4-(2-hydroxy-2-methyl-propionyl)-benzyl]phenyl}-2-ethyl-propane-1-one), 2-hydroxy-1-{4-[4-(2-hydroxy-2-methyl-propionyl)-phenoxy]-phenyl}-2-methyl-propan-1-one, 2-methyl-1-(4-methylthiophenyl)-2-morpholinopropane-1-one), 2-benzyl-2-dimethylamino-1-(4-morpholinophenyl)-butane-1-one, and (2-(dimethylamino)-2-[(4-methylphenyl)methyl]-1-[4-(4-morpholinyl) phenyl]-1-butanone).

Examples of acylphosphine photoinitiators include, but are not limited to, bis(2,4,6-trimethylbenzoyl)phenylphosphine oxide, bis(2,6-dimethoxybenzoyl)-2,4,4-trimethylpentyl phosphine oxide, bis(2,4,6-trimethylbenzoyl)-(2,4-dipentyloxyphenyl), 2,4,6-trimethylbenzoyl-diphenyl phosphine oxide and ethyl (2,4,6-trimethylbenzoyl) phenylphosphinate, Phenyl(2,4,6-trimethylbenzoyl)phosphinic acid, glycerol ethoxylated trimester (Omnipol® TP from IGM Resins B.V.).

Examples of the halomethyltriazines based photoinitiators are 2-[2-(4-methoxy-phenyl)-vinyl]-4,6-bis-trichloromethyl [1,3,5]triazine, 2-(4-methoxy-phenyl)-4,6-bis-trichloromethyl [1,3,5]triazine, 2-(3,4-dimethoxyphenyl)-4,6-bis-trichloromethyl [1,3,5]triazine, 2-methyl-4,6-bis-trichloromethyl [1,3,5]triazine.

Cationic photoinitiators can be also used as the further photoinitiators, when the photopolymerizable compositions according to the invention are used in hybrid systems (which in this connection mean mixtures of free-radically and cationically curing systems). Examples of suitable cationic photoinitiators are aromatic sulfonium, phosphonium or iodonium salts, as described e.g. in U.S. Pat. No. 4,950,581, or cyclopentadienylarene-iron(II) complex salts, e.g. (η⁶-isopropylbenzene)(η⁵-cyclopentadienyl) iron(II) hexafluorophosphate or photolatent acids based on oximes, as described, for example, in GB 2 348 644, U.S. Pat. Nos. 4,450,598, 4,136,055, WO 00/10972 and WO 00/26219.

Any pigment known to the person skilled in the art may be used in the photopolymerizable composition.

Depending upon the intended use, both inorganic and organic pigments may be used. Such additives are well known to the person skilled in the art; some examples are carbon black, iron oxides, such as iron oxide yellow, iron oxide red, chromium yellow, chromium green, nickel titanium yellow, ultramarine blue, cobalt blue, bismuth vanadate, cadmium yellow and cadmium red. Examples of organic pigments are mono- or bis-azo pigments, and also metal complexes thereof, phthalocyanine pigments, polycyclic pigments, e.g. perylene, anthraquinone, thioindigo, quinacridone or triphenylmethane pigments, and also diketo-pyrrolo-pyrrole, isoindolinone, e.g. tetrachloroisoindolinone, isoindoline, dioxazine, benzimidazolone and quinophthalone pigments. The pigments may be used in the formulations individually or in admixture

The addition of binders is particularly advantageous when the ethylenically unsaturated, free-radical polymerizable compounds are liquid or viscous substances. The choice of binder is made in accordance with the field of use and the properties required therefor, such as developability in aqueous and organic solvent systems, adhesion to substrates and sensitivity to oxygen. Suitable binders are, for example, polymers having a weight average molecular weight (Mw) of approximately from 5,000 Da to 2,000,000 Da, preferably from 10,000 Da to 1,000,000 Da. Illustrative examples are: homo- and copolymers of acrylates and methacrylates, e.g. copolymers of methyl methacrylate/ethyl acrylate/methacrylic acid, poly(methacrylic acid alkyl esters), poly(acrylic acid alkyl esters); cellulose esters and ethers, such as cellulose acetate, cellulose acetate butyrate, methylcellulose, ethylcellulose, polyvinylbutyral, polyvinylformal, cyclised rubber, polyethers such as polyethylene oxide, polypropylene oxide, polytetrahydrofuran, polystyrene, polycarbonates, polyurethanes, chlorinated polyolefins, e.g. polyvinyl chloride, co-polymers of vinyl chloride/vinylidene chloride, co-polymers of vinylidene chloride with acrylonitrile, methyl methacrylate and vinyl acetate, polyvinyl acetate, co-poly (ethylene/vinyl acetate), polymers such as polycaprolactam and poly(hexamethylene adipamide), polyesters such as poly(ethylene glycol terephthalate) and poly(hexamethylene glycol succinate).

The choice of additives is governed by the field of use in question and the properties desired for that field. Typical additives include thermal initiators, stabilizers, light stabilizers, fillers, colorants, antistatic agents, wetting agents, flow improvers, and adhesion enhancers.

For instance, especially in the case of pigmented compositions, the composition may also comprise, as additional additive, a thermal initiator, a compound that forms free radicals when heated, e.g. an azo compounds, such as 2,2′-azobis(4-methoxy-2,4-dimethylvaleronitrile), a triazene, diazosulfide, pentazadiene or a peroxy compound, for example a hydroperoxide or peroxycarbonate, e.g. tert-butyl hydroperoxide, as described e.g. in EP 245 639.

Suitable stabilizers are, for example, thermal inhibitors, such as hydroquinone, hydroquinone derivatives, p-methoxyphenol, β-naphthol or sterically hindered phenols, e.g. 2,6-di(tert-butyl)-p-cresol, which prevent premature polymerization. In order to increase dark storage stability it is possible to use, for example, copper compounds, such as copper naphthenate, stearate or octoate, phosphorus compounds, for example triphenylphosphine, tributylphosphine, triethyl phosphite, triphenyl phosphite or tribenzyl phosphite, quaternary ammonium compounds, e.g. tetramethylammonium chloride or trimethylbenzylammonium chloride, or hydroxylamine derivatives, e.g. N,N-diethylhydroxylamine. For the purpose of excluding atmospheric oxygen during polymerization it is possible to add paraffin or similar wax-like substances which, being insoluble in the polymer, migrate to the surface at the beginning of the polymerization and form a transparent surface layer which prevents air from entering.

It is also possible to add a light stabilizer, such as UV absorbers, e.g. hydroxyphenylbenzotriazole, hydroxyphenylbenzophenone, oxalic acid amide or hydroxyphenyl-s-triazine type. Such components can be used on their own or in the form of mixtures, with or without the use of sterically hindered amines (HALS).

All fallback positions and preferable embodiments of the photoinitiator package described above or below are applicable mutatis mutandis to the photopolymerizable composition according to the present aspect.

### Method

In a third aspect, the present invention is directed to a method for photocuring photopolymerizable compositions, coatings, adhesives and inks, said method comprising the following steps in the given order:
a) coating or printing the photopolymerizable composition according to the second aspect onto a substrate, and
b) photopolymerizing said coated or printed composition with a light source on said substrate.

Preferably the light source operates in the near-UV or visible range of the EM-spectrum.

All fallback positions and preferable embodiments of the photoinitiator package and the photopolymerizable composition described above or below are applicable mutatis mutandis to the method for photocuring photopolymerizable compositions, coatings, adhesives and inks according to the present aspect.

### Use

In a fourth aspect, the present invention is directed to a use of the photoinitiator package according to the first aspect in the production of printing inks, screen-printing inks, gravure printing inks, solder masks, etch offset-printing inks, flexographic-printing inks, gravure printing inks, ink jet inks, resist material, insulators, encapsulants, image-recording material, solder mask, passivation layer, protective coating, 3D-printing objects and molds, holographic applications, optical fiber coating, waveguide and lens, overprint varnish, wood, vinyl, metal and plastic coatings.

All fallback positions and preferable embodiments of the photoinitiator package described above or below are applicable mutatis mutandis to the use according to the present aspect.

In a final aspect, the present invention is directed to a use of a combination of one or more amines and one or more oxazole-based sensitizers for increasing the rate of surface curing in photopolymerizable compositions comprising one or more Norrish Type-I photoinitiators.

It is particularly preferred that the one or more Norrish Type-I photoinitiators are selected from mono- or bisacylphosphine oxide photoinitiators.

All fallback positions and preferable embodiments of the one or more mono- or bisacylphosphine oxide photoinitiators, coumarin-based sensitizers and/or the amines described in the first aspect are applicable mutatis mutandis to the use according to the present aspect.

Furthermore, it is preferred that the photopolymerizable composition is a photopolymerizable composition according to the second aspect. All fallback positions and preferable embodiments of the photopolymerizable composition of the second aspect are applicable mutatis mutandis to the use according to the present aspect.

It is particularly preferred that the combination of the one or more amines and one or more coumarin-based sensitizers achieve a greater increase in the rate of surface curing

In one embodiment, the effect of “increasing the rate of the surface curing” is achieved if the rate of surface curing in the presence of the combination of the one or more amines and one or more coumarin-based sensitizers, given as Tack free m/min, is at least 1.5 times as high as without the combination of the one or more amines and one or more oxazole-based sensitizers, more preferably at least 2.0 times as high, more preferably at least 3.0 times as high, most preferably at least 5.0 times as high.

### EXAMPLES

### A. Measurement Methods

Tack-free measurement: Tack-free refers to a coating condition whereby a coating is completely cured on surface. It is evaluated as follows: the formulation is spread with a thickness of 12 microns on a varnished cardboard using a bar-coater and photopolymerized under a light source. Then the thumb of the operator is brought into contact with the coating with a slightly pressure, if no fingerprints/signs remain on the surface the coating is perfectly cured. The maximum speed (m/min) at which no fingerprints/signs remain on the surface is given as value of tack-free. Higher maximum speeds correspond to higher reactivity.

### B. Experimental

### 1. Materials Used

The following commercially available compounds were used in the preparation of the inventive and comparative formulations:
PI-1: bis(2,4,6-trimethylbenzoyl) phenylphosphine oxide, CAS #: 162881-26-7, commercially available as Omnirad 819 from IGM Group B. V. (NL).
PI-2: bis(2,4,6-trimethylbenzoyl) octylphosphine oxide, prepared as in U.S. Pat. No. 5,534,559 A.
Si: 7-diethylamino-4-methylcoumarin, CAS #: 91-44-1, commercially available as Coumarin 1 from Merck KGaA (DE).
S2: 7-methoxycoumarin, CAS #: 531-59-9, commercially available from abcr GmbH (DE).
S3: 2,3,6,7-Tetrahydro-9-methyl-1H,5H,11H-[1]benzopyrano[6,7,8-ij]quinolizin-11-one, CAS #: 41267-76-9, commercially available as Coumarin 102 from abcr GmbH (DE).
S4: Coumarin, CAS #: 91-64-5, commercially available from abcr GmbH (DE).
S5: 7-diethylamino-3-phenylcoumarin, CAS #: 84865-19-0, commercially available from abcr GmbH (DE).
A1: 1H-azepine-1-propanoic acid, hexahydro-2,2-bis[[(1-oxo-2-propen-1-yl)oxy]methyl]butyl ester, commercially available as Photomer 4250 from IGM Group B. V. (NL).
A2: Triethanolamine, CAS #:102-71-6, commercially available from Merck KGaA (DE).
A3: poly(ethylene glycol)bis(p-dimethylaminobenzoate), CAS #: 71512-90-8, commercially available as Omnipol ASA from IGM Group B. V. (NL).
M-i: a 40:30:30 photopolymerizable monomer blend of M1, M2 and M3.
M-ii: a 50:15:15:20 photopolymerizable monomer blend of M1, M4, M5 and M6.
M-iii: a 50:25:25 photopolymerizable monomer blend of M1, M4 and M6.
M1: bisphenol Y epoxy diacrylate, CAS #: 55818-57-0, commercially available as Photomer 3016 from IGM Group B. V. (NL).
M2 glyceryl [4 PO]triacrylate, CAS #: 52408-84-1, commercially available as Photomer 4094 from IGM Group B. V. (NL).
M3 Trimethylolpropane triacrylate, CAS #: 15625-89-5, commercially available as Photomer 4006 from IGM Group B. V. (NL)
M4 blend of pentaerythritol tri and tetra acrylate, CAS #: 3524-68-3 and 4986-89-4, commercially available as Photomer 4335 from IGM Group B. V. (NL).
M5 dipentaerythritol penta/hexaacrylate, CAS #: 1384855-91-7, commercially available as Photomer 4600 from IGM Group B. V. (NL).
M6 pentaerythritol [5 EO]tetraacrylate, CAS #: 51728-26-8, commercially available as Photomer 4172 from IGM Group B. V. (NL).

### 2. Formulations (Photopolymerizable Compositions)

The following reference, inventive and comparative formulations were used in the surface curing evaluation, wherein the amounts of each component are given in percentage by weight (wt.-%). The formulations were prepared by adding to the photopolymerizable monomer blend M (i.e. M-i, M-ii, or M-iii), the photoinitiator, the sensitizer and the amine at the concentration indicated in Table 1 at room temperature. The formulations were stirred at 60° C. for 2 hours and after cooling at room temperature were spread with a thickness of 12 microns on a varnished cardboard using a bar-coater. Thereafter, the formulations were photopolymerized using a light source (Table 2):

TABLE 1a
Recipes of inventive and comparative formulations using monomer blend M-i

| | CE1 | CE2 | CE3 | IE1 | CE4 | IE2 | IE3 | CE5 | IE4 | IE5 | IE6 |
|---|---|---|---|---|---|---|---|---|---|---|---|
| PI-1 | 10 | 10 | 10 | 10 | 10 | 10 | 10 | 10 | 10 | 10 | 10 |
| S1 | — | — | 0.5 | 0.5 | 1.5 | 1.5 | 1.5 | 10 | 10 | 10 | 10 |
| A1 | — | 5 | — | 5 | — | 5 | — | — | 5 | — | — |
| A2 | — | — | — | — | — | — | 5 | — | — | 5 | — |
| A3 | — | — | — | — | — | — | — | — | — | — | 5 |
| M-i | 90 | 85 | 89.5 | 84.5 | 88.5 | 83.5 | 83.5 | 80 | 75 | 75 | 75 |

TABLE 1b
further recipes of inventive and comparative formulations using monomer blend

| | CE6 | IE7 | CE7 | IE8 | CE8 | IE9 | CE9 | IE10 | CE10 | CE11 | IE11 |
|---|---|---|---|---|---|---|---|---|---|---|---|
| PI-1 | 10 | 10 | 10 | 10 | 10 | 10 | 10 | 10 | — | — | — |
| PI-2 | — | — | — | — | — | — | — | — | 10 | 10 | 10 |
| S1 | — | — | — | — | — | — | — | — | — | 1.5 | 1.5 |
| S2 | 1.5 | 1.5 | — | — | — | — | — | — | — | — | — |
| S3 | — | — | 1.5 | 1.5 | — | — | — | — | — | — | — |
| S4 | — | — | — | — | 1.5 | 1.5 | — | — | — | — | — |
| S5 | — | — | — | — | — | — | 1.5 | 1.5 | — | — | — |
| A1 | — | 5 | — | 5 | — | 5 | — | 5 | — | — | 5 |
| M-i | 88.5 | 83.5 | 88.5 | 83.5 | 88.5 | 83.5 | 88.5 | 83.5 | 90 | 88.5 | 83.5 |

TABLE 1c
Recipes of inventive and comparative formulations
using monomer blends M-ii and M-iii

| | CE12 | CE13 | IE12 | CE14 | CE15 | CE16 | IE13 | CE17 | IE14 | IE15 |
|---|---|---|---|---|---|---|---|---|---|---|
| PI-2 | 5.0 | 3.5 | 3.60 | 5.0 | 4.0 | 4.0 | 4.0 | 4.0 | 4.0 | 3.60 |
| S1 | — | 1.5 | 0.40 | — | — | 1.0 | 1.0 | — | — | 0.24 |
| S3 | — | — | — | — | — | — | — | 1.0 | 1.0 | — |
| A1 | — | — | — | — | — | — | 1.0 | — | 1.0 | — |
| A3 | — | — | 1.13 | — | — | — | — | — | — | 1.13 |
| M-ii | 95.0 | 95.0 | 94.87 | — | — | — | — | — | — | — |
| M-iii | — | — | — | 95.0 | 96.0 | 95.0 | 94.0 | 95.0 | 94.0 | 95.03 |

TABLE 1d
Recipes of formulations for control experiments

| | RE1 | RE2 | CE18 | IE16 |
|---|---|---|---|---|
| PI-1 | — | — | 4.0 | 4.0 |
| S1 | 5.0 | 5.0 | 2.0 | 1.0 |
| A3 | — | 5.0 | — | 1.0 |
| M-ii | 95.0 | 90.0 | 94.0 | 94.0 |

### 3. Surface Photocuring Evaluation

The inventive and comparative formulations were evaluated for their surface photocuring ability, according to the testing method provided in the determination methods, using different light sources (with the values in Table 2 corresponding to the maximum Tack-free speed in m/min):

TABLE 2a
Performance of the M-i formulations in surface photocuring

| | Lamp 1 | Lamp 2 | Lamp 3 | Lamp 4 | Lamp 5 |
|---|---|---|---|---|---|
| CE1 | 57 | 27 | 12 | 11 | 16 |
| CE2 | 98 | 33 | 21 | 19 | 27 |
| CE3 | 98 | 39 | 18 | 30 | 28 |
| IE1 | >100 | 53 | 32 | 57 | 48 |
| CE4 | >100 | 42 | 28 | 43 | 30 |
| IE2 | >100 | 62 | 57 | 74 | 21 |
| IE3 | >100 | 48 | 38 | 45 | 42 |
| CE5 | 66 | 31 | 58 | 38 | <10 |
| IE4 | 95 | 58 | 75 | 46 | <10 |
| IE5 | 94 | 52 | 77 | 38 | 12 |
| IE6 | >100 | 34 | 48 | 33 | <10 |
| CE6 | 99 | 31 | 13 | 11 | 19 |
| IE7 | >100 | 44 | 18 | 15 | 24 |
| CE7 | 99 | 36 | 19 | 18 | 27 |
| IE8 | >100 | 46 | 24 | 26 | 27 |
| CE8 | 91 | 27 | 12 | 11 | 16 |
| IE9 | 99 | 35 | 16 | 14 | 21 |
| CE9 | 58 | 27 | 12 | 11 | 16 |
| IE10 | 75 | 39 | 14 | 13 | 18 |
| CE10 | 46 | 12 | <10 | <10 | <10 |
| CE11 | 96 | n/m | 67 | 46 | <10 |
| IE11 | >100 | 83 | 78 | 56 | 13 |

* n/m = not measured
Lamp 1: a UV Hg lamp with an intensity of 120 W/cm, at a distance of 8 cm.
Lamp 2: a UV Hg lamp with an intensity of 85 W/cm, at a distance of 8 cm.
Lamp 3: a UV LED lamp with a wavelength of 395 nm and an intensity of 4 W/cm², at a distance of 0.5 cm.
Lamp 4: a UV LED lamp with a wavelength of 365 nm and an intensity of 4 W/cm², at a distance of 0.5 cm.
Lamp 5: a UV LED lamp with a wavelength of 278 nm and an intensity of 4 W/cm², at a distance of 0.5 cm.

TABLE 2b
Performance of the M-ii and M-iii
formulations in surface photocuring

| | Lamp 1 | Lamp 6 | Lamp 7 |
|---|---|---|---|
| CE12 | 60 | 28 | 37 |
| CE13 | 82 | 26 | 38 |
| IE12 | 95 | 52 | 73 |
| CE14 | 60 | 26 | 31 |
| CE15 | 47 | 18 | 22 |
| CE16 | 73 | 27 | 33 |
| IE13 | 99 | 95 | 100 |
| CE17 | 58 | 28 | 37 |
| IE14 | 75 | 37 | 52 |
| IE15 | 77 | 49 | 68 |

Lamp 1: a UV Hg lamp with an intensity of 120 W/cm, at a distance of 8 cm.
Lamp 6: a UV LED lamp with a wavelength of 395 nm and an intensity of 16 W/cm², at a distance of 0.5 cm.
Lamp 7: a UV LED lamp with a wavelength of 365 nm and an intensity of 16 W/cm², at a distance of 0.5 cm.

TABLE 2c
Control experiments

| | Lamp 1 | Lamp 2 | Lamp 3 | Lamp 4 | Lamp 6 | Lamp 7 |
|---|---|---|---|---|---|---|
| RE1 | 15 | n/m | n/m | n/m | <10 | <10 |
| RE2 | <10 | n/m | n/m | n/m | <10 | <10 |
| CE18 | 90 | 30 | 60 | 80 | 99 | >100 |
| IE16 | 95 | 32 | 63 | 90 | >100 | >100 |

* n/m = not measured
Lamp 1: a UV Hg lamp with an intensity of 120 W/cm, at a distance of 8 cm.
Lamp 2: a UV Hg lamp with an intensity of 85 W/cm, at a distance of 8 cm.
Lamp 3: a UV LED lamp with a wavelength of 395 nm and an intensity of 4 W/cm², at a distance of 0.5 cm.
Lamp 4: a UV LED lamp with a wavelength of 365 nm and an intensity of 4 W/cm², at a distance of 0.5 cm.
Lamp 6: a UV LED lamp with a wavelength of 395 nm and an intensity of 16 W/cm², at a distance of 0.5 cm.
Lamp 7: a UV LED lamp with a wavelength of 365 nm and an intensity of 16 W/cm², at a distance of 0.5 cm.

As can be seen from the data in Table 2a, the use of coumarin-based sensitizers S1 to S5 in combination with photoinitiators PI-1 and PI-2 generally resulted in the improvement of the curing rate (CE3/CE4/CE5 vs. CE1 (PI-1/S1), CE6 vs. CE1 (PI-1/S2), CE7 vs. CE1 (PI-1/S3), CE8 vs. CE1 (PI-1/S4), CE9 vs. CE1 (PI-1/S5), and CE11 vs. CE10 (PI-2/S1)) or in some cases the curing rate was largely unaffected (e.g. when S2, S4 and S5 are used with Lamp 2, Lamp 3 or Lamp 4).

Irrespective of whether the use of coumarin-based sensitizers improve the curing rate or not, the use of amines A1 to A3 has been shown to (further) improve the curing rate by interacting synergistically with the sensitizer to improve the effect of the Type-I photoinitiator. As can be seen by comparing CE2 with CE1, the amine alone does have an effect on the curing rate of the Type-I photoinitiator; however, the effect when both an amine and a sensitizer is used is generally more than would be predicted from a simple additive effect (i.e. the amine and sensitizer act synergistically).

In IE1, wherein only 0.5 wt.-% of the coumarin-based sensitizer S1 is used, the effect of the amine (A1) is particularly pronounced, with the amine more than doubling the effect of the sensitizer (e.g. Lamp 3 improvements of 14 m/min due to addition of amine (CE3 to IE1) and 6 m/min due to addition of sensitizer (CE1 to CE3)).

A similar effect is observed when 1.5 wt.-% of S1 is used, with amines A1 to A3 all offering improvements. A2 is particularly effective at synergistically interacting with the sensitizer when Lamp 5 is used (IE3 vs. CE4).

In the above cases, the effect when Lamp 1 is used is difficult to ascertain, since the activity of the inventive compositions exceeded the limits of the test; however, when 10 wt.-% of S1 is used, the true effect of the amine can be seen, with IE4 to IE6 having drastically improved surface cure relative to CE5 (and CE1).

IE7 to IE10 demonstrate the effect of amine A1 in combination with diverse coumarin-based sensitizers S2 to S5 (relative to CE6 to CE9, respectively).

Finally, similar improvements can be seen when using PI-2 (i.e. IE11 vs. CE11), with good surface curing seen for Lamps 1 to 4 in particular.

The data in Table 2b further reinforces the conclusions drawn from Table 2a, with lower amounts of photopolymerization package also demonstrated to be capable of achieving good surface curing.

The results of a number of control experiments are shown in Table 2c. RE1 and RE2 demonstrate that the coumarin-based sensitizers do not act as Type-I (RE1) or Type-II (RE2) photoinitiators. Furthermore, IE16/CE18 demonstrate that a 50:50 combination of a sensitizer and an amine is more effective than the sensitizer alone.

1. A photoinitiator package comprising:
a) one or more mono- or bisacylphosphine oxide photoinitiators,
b) one or more coumarin-based sensitizers, each having a structure according to formula (I): 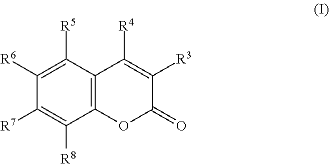
wherein R³ is selected from the group consisting of hydrogen, C₁-C₁₀ alkyl, C₆-C₁₄ aryl, and heteroaryl,
R⁴ is selected from the group consisting of hydrogen, C₁-C₁₀ alkyl, wherein said C₁-C₁₀ alkyl may be substituted by one or more fluorine atoms, and OR¹, and
each of R⁵ to R¹ is independently selected from the group consisting of hydrogen, halogen, C₁-C₁₀ alkyl, OR¹, and NR²₂;
wherein each instance of R¹ is independently selected from hydrogen, C₁-C₁₀ alkyl and C₆-C₁₄ aryl, and each instance of R² is independently selected from hydrogen, C₁-C₁₀ alkyl and C₆-C₁₄ aryl, wherein each instance of R¹ to R⁸ may optionally be joined to one or more further instances of R¹ to R⁸ to form one or more 5-membered or 6-membered rings, and
c) one or more amines.

2. The photoinitiator package according to claim 1, wherein each of the one or more amines has a nitrogen atom having a direct single bond to either a methyl group, a methylene group or a methanetriyl group.

3. The photoinitiator package according to claim 1, wherein at least one of the one or more bisacylphosphine oxide photoinitiators has a structure according to any one of formulae (II) to (V): 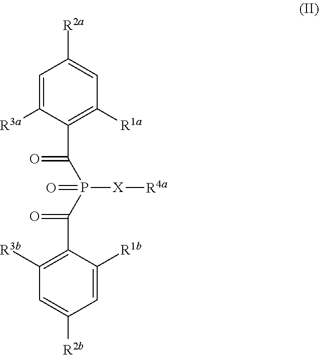
wherein each instance of R^{1a}, R^{2a}, R^{3a}, R^{1b}, R^{2b} and R^{3b} is independently selected from the group consisting of C₁-C₄ alkyl, C₁-C₄ alkoxy or halogen;
wherein X is selected from the group consisting of direct single bond, O, S, NR^{5a}, —CH₂CO₂—, and —CH₂CH₂CO₂—;
wherein R^{4a} is selected from the group consisting of hydrogen, (CO)R^{6a}, (CO)OR^{6a}(CO)NR^{5a}R^{6a}, (SO₂)R^{6a}, [Si(R^{7a})(R^{8a})]ₘ—Si(R^{7a})(R^{8a})(R^{9a}), [Si(R^{7a})(R^{8a})O]ₘ—Si(R^{7a})(R^{8a})(R^{9a}); or
wherein R^{4a} is C₁-C₂₈ alkyl or C₂-C₂₈ alkyl which is interrupted by one or more O, NR^{5a}S, (CO), (CO)O, or SO₂, wherein said C₁-C₂₈ alkyl or interrupted C₂-C₂₈ alkyl is unsubstituted or substituted by one or more substituents selected from the group consisting of OH, C₆-C₁₄ aryl, [Si(R^{7a})(R^{8a})]ₘ—Si(R^{7a})(R^{8a})(R^{9a}), [Si(R^{7a})(R^{8a})—O]ₘ—Si(R^{7a})(R^{8a})(R^{9a}), N(R^{5a})₂, 2-oxiranyl, C₃-C₁₂ cycloalkyl which is unsubstituted or substituted by C₁-C₄ alkyl, C₁-C₄ alkoxy or by OH, C₃-C₁₂ cycloalkyl which is interrupted by one or more O, NR^{5a} or S and which interrupted C₃-C₁₂ cycloalkyl is unsubstituted or substituted by C₁-C₄ alkyl, C₁-C₄ alkoxy or by OH, and C₆-C₁₄ aryl which is unsubstituted or substituted by C₁-C₄ alkyl, C₁-C₄ alkoxy or by OH; or
wherein R^{4a} is C₆-C₁₀ aryl which is unsubstituted or substituted by one or more C₁-C₁₂ alkyl, C₂-C₂₀alkyl which is interrupted by one or more O, C₁-C₁₂-alkoxy or by OH; or
wherein, in cases where X is NR^{5a}, R^{4a} together with R^{5a} and the N-atom forms a 5 or 6-membered saturated ring which is uninterrupted or interrupted by O or NR^{5a} and which uninterrupted or interrupted ring is unsubstituted or substituted by one or more C₁-C₄ alkyl, C₁-C₄ alkoxy or by OH; or
wherein R^{4a} is selected from the group consisting of structures (A) to (G): 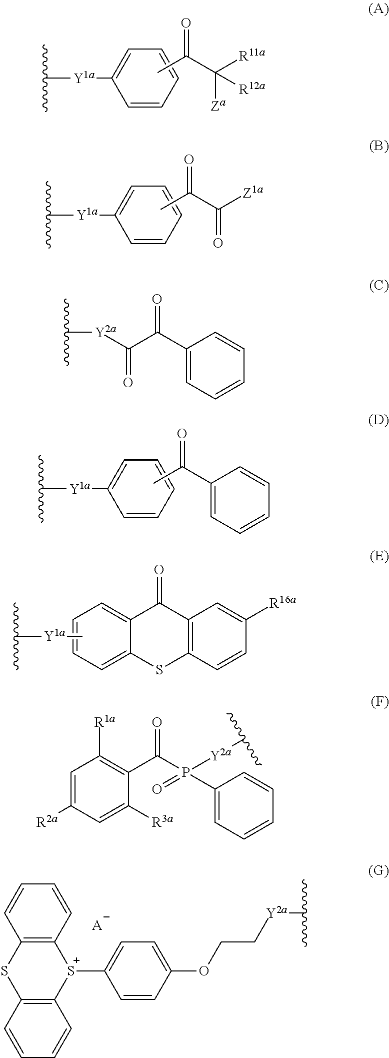
wherein all options for R^{4a} may be further substituted by one or more groups, selected from OH and R^{17a};
wherein R^{17a} is 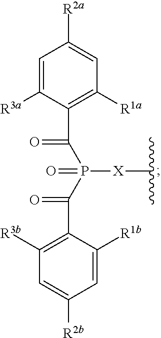
wherein A is PF₆, SbF₆, AsF₆ or B(C₆F₅)₄;
wherein R^{5a} is hydrogen, (CO)R^{6a}, phenyl, C₁-C₁₂ alkyl, C₂-C₁₂ alkyl which is interrupted by one or more O, wherein said C₁-C₁₂ alkyl or interrupted C₂-C₁₂ alkyl is unsubstituted or substituted by one or more C₃-C₇ cycloalkyl, OH or by NCO, C₃-C₁₂ cycloalkyl which is unsubstituted or substituted by one or more C₁-C₄ alkyl, C₁-C₄ alkoxy, OH or by NCO;
wherein R^{6a} is C₁-C₁₂ alkyl or C₂-C₁₂ alkyl which is interrupted by one or more O, wherein said C₁-C₁₂ alkyl or interrupted C₂-C₁₂ alkyl is unsubstituted or substituted by one or more C₃-C₇ cycloalkyl, OH, NCO or by phenyl which is substituted by NCO; or
wherein R^{6a} is C₃-C₁₂ cycloalkyl or C₂-C₁₀ alkenyl which is unsubstituted or substituted by one or more C₁-C₄ alkyl, OH or C₁-C₄ alkoxy; or
wherein R^{6a} is C₆-C₁₄ aryl which is unsubstituted or substituted by C₁-C₁₂ alkyl, C₁-C₁₂ alkoxy, NCO or by NCO-substituted C₁-C₁₂ alkyl; or
wherein if the group N(R^{5a})₂ is present, then one instance of R^{5a} may be (CO)R^{6a}, wherein the other instance of R^{5a} and R^{6a}, together with the N and CO moieties form a 5- or 6-membered ring, which is either uninterrupted or interrupted by O or NR^{5a} and which uninterrupted or interrupted ring is either unsubstituted or substituted by one or more C₁-C₄ alkyl, C₁-C₄ alkoxy, or by OH;
wherein R^{7a}, R^{8a}, and R^{9a} are each independently selected from the group consisting of C₁-C₄ alkyl, C₆-C₁₄ aryl or C₁-C₄ alkoxy;
wherein m is an integer in the range from 0-10;
wherein Y1a is selected from the group consisting of a direct single bond, O, S, NR^{5a}O(CO)—* or O(CO)CH₂O—*, wherein the asterix denotes the bond to the phenyl ring of the group (A), (B), (D), or (E);
wherein Y^{2a} is selected from the group consisting of a direct single bond, O, S or NR^{5a};
wherein R^{11a} and R^{12a} independently of each other are C₁-C₁₀ alkyl, C₂-C₁₀ alkenyl or phenyl, C₁-C₄ alkyl which is unsubstituted or substituted by C₁-C₄ alkyl, or R^{11a} and R^{12a} together with the C-atom to which they are attached form a cyclohexane or cyclopentane ring;
wherein Z^{a} is OH or NR^{13a}R^{14a};
wherein Z^{1a} is C₁-C₁₂ alkoxy or C₂-C₁₂ alkoxy which is interrupted by one or more O, wherein said C₁-C₁₂ alkoxy or interrupted C₂-C₁₂ alkoxy is unsubstituted or substituted by OH;
wherein R^{13a} and R^{14a} independently of each other are C₁-C₁₂ alkyl, C₁-C₁₂ alkyl which is substituted by one or more OH or halogen; or
wherein R^{13a} and R^{14a} together with the N-atom to which they are attached form a 5- or 6-membered unsaturated or saturated ring, which ring is uninterrupted or interrupted by O or NR^{15a}; wherein R^{15a} is C₁-C₄ alkyl;
wherein R^{16a} is hydrogen or C₁-C₄ alkyl; provided that
(i) if R^{1a}, R^{2a} and R^{3a} as C₁-C₄ alkyl are methyl and X is O, then R⁴ as C₁-C₂₈ alkyl is not methyl, ethyl, n-propyl, 2-propyl, n-butyl, sec-butyl, tert-butyl, n-hexyl;
(ii) if R^{1a} and R^{3a} as halogen are Cl, R^{2a} is hydrogen and X is O, then R^{4a} as substituted C₃-C₁₀ aryl is not 4-butyl-phenyl; and
(iii) if R^{1a} and R^{3a} as C₁-C₄ alkoxy are methoxy, R^{2a} is hydrogen and X is NR^{5a}, and R^{4a} together with R^{5a} and the N-atom forms a 5 or 6-membered saturated ring, then said ring is not a piperidine ring; 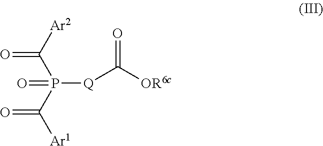
wherein Ar¹ and Ar² are each independently 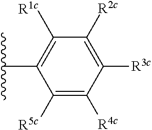
or naphthyl which is unsubstituted or substituted one or more times by R^{1c}, R^{2c}, R^{3c}, R^{4c}, or R^{5c};
wherein R^{1c} and R^{5c} are each independently selected from the group consisting of C₁-C₄ alkyl, C₁-C₄ alkoxy or halogen;
wherein R^{3c} is selected from the group consisting of hydrogen, C₁-C₄ alkyl, halogen, C₁-C₄ alkoxy or C₂-C₂₀alkoxy which is interrupted by one or more O;
wherein Q is C₁-C₄ alkylene;
wherein R^{2c} and R^{4c} independently of each other are hydrogen or PG^{c}-Y^{c}—Z^{c}—X^{c}—;
wherein PG^{c} is a polymerizable group or methyl or ethyl;
wherein Y^{c} is a direct single bond, O or S;
wherein X^{c} is a direct single bond, O or S;
wherein Z^{c} is a direct single bond, C₁-C₂₀alkylene or C₂-C₂₀alkylene which is interrupted by one or more O;
wherein R^{6c} is C₃-C₃₀ alkyl which is unsubstituted or substituted by one or more of the groups selected from OH and 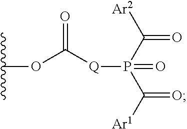
or
wherein R^{6c} is C₃-C₂₈ alkyl which is interrupted by one or more O or C₃-C₈ cycloalkylene and which interrupted C₃-C₂₈ alkyl is unsubstituted or substituted by one or more
of the groups selected from OH and 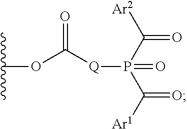 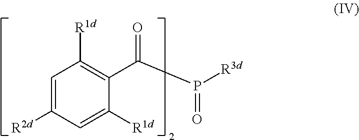
wherein R^{1d} is C₁-C₄ alkyl, C₁-C₄ alkoxy or halogen;
wherein R^{2d} is hydrogen, C₁-C₄ alkyl, C₁-C₄ alkoxy or halogen; and
wherein R^{3d} is C₁-C₂₀alkyl, cyclopentyl, cyclohexyl, phenyl-C₁-C₄ alkyl, naphthyl, biphenylyl or an O-, S- or N-containing 5- or 6-membered heterocyclic ring, the naphthyl, biphenylyl and O-, S- or N-containing 5- or 6-membered heterocyclic ring radicals being unsubstituted or substituted by C₁-C₄ alkyl, C₁-C₄ alkoxy, halogen, C₁-C₄ alkylthio; or
wherein R^{3d} is 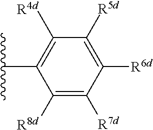
wherein R^{4d}, R^{5d}, R^{6d}, R^{7d} and R^{8d} are each independently selected from the group consisting of hydrogen, halogen, C₁-C₂₀alkyl, cyclopentyl, cyclohexyl, C₂-C₁₂ alkenyl, C₂-C₂₀ alkyl interrupted by one or more non-consecutive O atoms, phenyl-C₁-C₄ alkyl, C₁-C₂₀alkoxy, or phenyl that is unsubstituted or substituted by one or two C₁-C₄ alkyl or/and C₁-C₄ alkoxy substituents; and 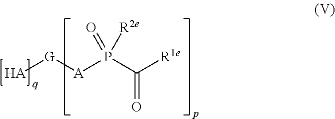
wherein each A represents independently of one another O, S, NR^{3e};
wherein G is a residue of the multifunctional compound (core) G-(A-H)_{p+q}, wherein each A-H represents an alcoholic or amino or thiol group;
wherein p and q are both integer numbers, p+q is an integer in the range from 3 to 10, and p is an integer in the range from 3 to 8;
wherein R^{1e} and R^{2e} are each independently selected from the group consisting of C₁-C₁₈ alkyl, C₆-C₁₂ aryl and C₅-C₁₂ cycloalkyl, each of which is uninterrupted or interrupted by one or more oxygen and/or sulfur atoms and/or one or more substituted or unsubstituted amino groups, or are a five- to six-membered heterocyclyl containing oxygen and/or nitrogen and/or sulfur atoms;
where each of said groups may be substituted by aryl, alkyl, aryloxy, alkoxy, heteroatoms and/or heterocyclic radicals; R^{2e} may also be (CO)R^{1e};
wherein R^{3e} is hydrogen or C₁-C₄ alkyl.

4. The photoinitiator package according to claim 1, wherein at least one of the one or more bisacylphosphine oxide photoinitiators has a structure according to formula (VI): 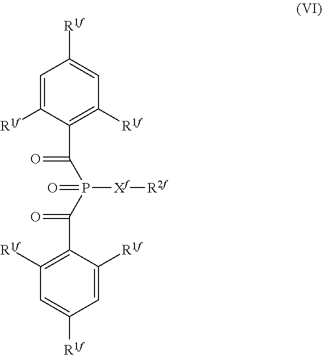
wherein each instance of R^{1f} is independently selected from the group consisting of C₁-C₄ alkyl;
wherein X^{f} is selected from the group consisting of direct single bond, O, S, NR^{4f}, —CH₂CO₂—, and —CH₂CH₂CO₂—;
wherein R^{2f} is selected from the group consisting of C₁-C₄₀ alkyl and interrupted C₂-C₄₀ alkyl being interrupted by one or more O or C₃-C₈ cycloalkylene, wherein said C₁-C₄₀ alkyl or interrupted C₂-C₄₀ alkyl may be unsubstituted or substituted by one or more groups selected from OH and R^{3f};
wherein R^{3f} is 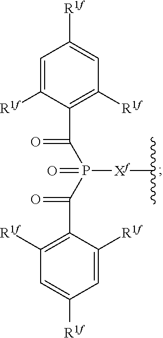
wherein R^{4f} is selected from the group consisting of hydrogen, (CO)R^{5f}, phenyl, C₁-C₁₂ alkyl, C₂-C₁₂ alkyl being interrupted by one or more O, wherein said C₁-C₁₂ alkyl or interrupted C₂-C₁₂ alkyl is unsubstituted or substituted by one or more C₃-C₇ cycloalkyl, OH or by NCO, C₃-C₁₂ cycloalkyl which is unsubstituted or substituted by one or more C₁-C₄ alkyl, C₁-C₄ alkoxy, OH or by NCO; and
wherein R^{5f} is selected from the group consisting of C₁-C₁₂ alkyl or C₂-C₁₂ alkyl which is interrupted by one or more O, wherein said C₁-C₁₂ alkyl or interrupted C₂-C₁₂ alkyl is unsubstituted or substituted by one or more C₃-C₇-cycloalkyl, OH, NCO or by phenyl which is substituted by NCO; C₃-C₁₂ cycloalkyl; C₂-C₁₀ alkenyl which is unsubstituted or substituted by one or more C₁-C₄ alkyl, OH or C₁-C₄ alkoxy; C₆-C₁₄ aryl which is unsubstituted or substituted by C₁-C₁₂ alkyl, C₁-C₁₂ alkoxy, NCO or by NCO-substituted C₁-C₁₂ alkyl.

5. The photoinitiator package according to claim 1, wherein R³ is selected from the group consisting of hydrogen and C₁-C₁₀ alkyl, and/or wherein R⁴ is selected from the group consisting of hydrogen and C₁-C₁₀ alkyl.

6. The photoinitiator package according to claim 1, wherein R⁷ is selected from the group consisting of OR¹, and NR²₂.

7. The photoinitiator package according to claim 1, wherein the coumarin-based sensitizers, each having a structure according to formula (I) are each independently selected from the group consisting of coumarin, 7-amino-4-(trifluoromethyl)coumarin, 3-(2-benzothiazolyl)-7-(diethylamino)coumarin, 7-hydroxy-4-(trifluoromethyl)coumarin, 7-(ethylamino)-4,6-dimethylcoumarin, 7-methoxy-4-(trifluoromethyl)coumarin, 7-ethoxy-4-(trifluoromethyl)coumarin, 7-amino-4-methylcoumarin, 7-(diethylamino)-4-methylcoumarin, 3-(2-benzoxazolyl)-7-(diethylamino)coumarin, 7-methylcoumarin, 7-methoxycoumarin, 4-hydroxycoumarin, 5,7-dimethoxycoumarin, 3-(3-biphenyl-4-yl-1,2,3,4-tetrahydro-1-naphthyl)-4-hydroxycoumarin, 6-methylcoumarin, 3-chloro-7-hydroxy-4-methylcoumarin, 7-hydroxycoumarin, 7-hydroxy-6-methoxycoumarin, 7-methoxy-6-hydroxycoumarin, 6-hydroxycoumarin, 7,8-dihydroxy-4-methylcoumarin, 7-Hydroxy-4-methylcoumarin, 7-(dimethylamino)-4-methylcoumarin, 2,3,6,7-Tetrahydro-9-methyl-1H,5H,11H-[1]benzopyrano[6,7,8-ij]quinolizin-11-one, 7-(diethylamino)-4-(trifluoromethyl)-coumarin, and 7-(ethylamino)-4-(trifluoromethyl)coumarin.

8. The photoinitiator package according to claim 1, wherein the photoinitiator package comprises:
a) an amount in the range from 40 to 98.9 wt.-%, relative to the total weight of the photoinitiator package, of the one or more mono- or bisacylphosphine oxide photoinitiators,
b) an amount in the range from 0.1 to 50 wt.-%, relative to the total weight of the photoinitiator package, of the one or more coumarin-based sensitizers, each having a structure according to formula (I), and
c) an amount in the range from 1.0 to 45 wt.-%, relative to the total weight of the photoinitiator package, of the one or more amines.

9. The photoinitiator package according to claim 1, wherein the only photoinitiators present in said photoinitiator package are Norrish Type-I photoinitiators or cationic photoinitiators.

10. A photopolymerizable composition, comprising:
a) one or more ethylenically unsaturated, free-radical polymerizable compounds;
b) the photoinitiator package according to claim 1.

11. The photopolymerizable composition according to claim 10, wherein the photopolymerizable composition comprises:
a) an amount in the range from 30 to 99.0 wt.-%, relative to the total weight of the photopolymerizable composition, of the one or more ethylenically unsaturated, free-radical polymerizable compounds;
b) an amount in the range from 0.5 to 50 wt.-%, relative to the total weight of the photopolymerizable composition, of the photoinitiator package according to claim 1.

12. The photopolymerizable composition according to claim 10, wherein the photopolymerizable composition further comprises one or more, of the following components:
c) an amount in the range from 0.5 to 30 wt.-% of one or more further photoinitiators, one or more photosensitizers and/or one or more co-initiators;
d) an amount in the range from 0.1 to 30 wt.-%, relative to the total weight of the photopolymerizable composition, of one or more pigments;
e) an amount in the range from 5.0 to 60 wt.-%, relative to the total weight of the photopolymerizable composition, of one or more binders; and
f) an amount in the range from 0.01 to 10 wt.-%, relative to the total weight of the photopolymerizable composition, of one or more additives.

13. A method for photocuring photopolymerizable compositions, coatings, adhesives and inks, said method comprising the following steps in the given order:
a) coating or printing a photopolymerizable composition according to claim 10 onto a substrate, and
b) photopolymerizing said coated or printed composition with a light source on said substrate.

14. (canceled)

15. (canceled)
